(19) United States
(12) Patent Application Publication
(10) Pub. No.: US 2003/0209432 A1
(43) Pub. Date: Nov. 13, 2003

(54) Methods and compositions relating to electrical detection of nucleic acid reactions

(76) Inventors: Vi-En Choong, Chandler, AZ (US); Sean R. Gallagher, Claremont, CA (US); Mike Gaskin, Chandler, AZ (US); Changming Li, Phoeniz, AZ (US); George Maracas, Phoenix, AZ (US); Song Shi, Phoenix, AZ (US)

Correspondence Address: Robin M Silva, Dorsey & Whitney, Intellectual Property Department, Four Embarcadero Center Suite 3400, San Francisco, CA, 94111-4187, US

(21) Appl. No.: 10/149,319

(22) PCT Filed: Dec. 11, 2000
(86) PCT No.: PCT/US00/33497

(51) Int. Cl. G01N 27/26

(52) U.S. Cl. 204/403.13; 204/403.14

(57) ABSTRACT

This invention relates to the detection of molecular interactions between biological molecules. Specifically, the invention relates to electrical detection of interactions such as hybridization between nucleic acids or peptide antigen-antibody interaction using arrays of peptides or oligonucleotides. In particular, the invention relates to an apparatus and methods for detecting nucleic acid hybridization or peptide binding using electronic methods including AC impedance. In some embodiments, no electrochemical or other label moieties are used. In others, electrochemically active labels are used to detect reactions on hydrogel arrays, including genotyping reactions such as the single base extension reaction.

This is a continuing application of U.S. Ser. Nos. 09/458,501, filed Dec. 9, 1999; 09/459,685, filed Dec. 13, 1999 and 09/458,533, filed Dec. 9, 1999, all of which are expressly incorporated by reference herein.

### FIELD OF THE INVENTION

This invention relates to the detection of molecular interactions between biological molecules. Specifically, the invention relates to electrical detection of interactions such as hybridization between nucleic acids or peptide antigen-antibody interactions using arrays of peptides or oligonucleotides. In particular, the invention relates to an apparatus and methods for detecting nucleic acid hybridization or peptide binding using electronic methods including AC impedance. In some embodiments, no electrochemical or other label moieties are used. In others, electrochemically active labels are used to detect reactions on hydrogel arrays, including genotyping reactions such as the single base extension reaction.

### BACKGROUND OF THE INVENTION

A number of commonly-utilized biological applications, including for example, diagnoses of genetic disease, analyses of sequence polymorphisms, and studies of receptor-ligand interactions, rely on the ability of analytical technologies to readily detect events related to the interaction between probe and target molecules. While these molecular detection technologies have traditionally utilized radioactive isotopes or fluorescent compounds to monitor probe-target interactions, methods for the electrical detection of molecular interactions have provided an attractive alternative to detection techniques relying on radioactive or fluorescent labels.

Electrical and electrochemical detection techniques are based on the detection of alterations in the electrical properties of an electrode arising from interactions between probe molecules on the surface of the electrode and target molecules in the reaction mixture. Electrical or electrochemical detection eliminates many of the disadvantages inherent in use of radioactive or fluorescent labels to discern molecular interactions. This process offers, for example, a detection technique that is safe, inexpensive, and sensitive, and is not burdened with complex and onerous regulatory requirements.

However, despite these advantages, there are a number of obstacles in using electrical or electrochemical detection techniques for analyzing molecular interactions. One such obstacle is the requirement, in some methods, of incorporating an electrochemical label into the target molecule. For example, labeled target molecules have been used to increase the signal produced upon the formation of nucleic acid duplexes during hybridization assays.

For example, Meade et al. (in U.S. Pat. Nos. 5,591,578, 5,705,348, 5,770,369, 5,780,234 and 5,824,473) provide methods for the selective covalent modification of nucleic acids with redox-active moieties such as transition metal complexes. Meade et al. further disclose nucleic acid hybridization assays employing such covalently-modified nucleic acid molecules. Similar work is further disclosed in U.S. Pat. No. 6,090,933 and WO 98/20162, WO 98/12430, WO 00/16089, WO 99/57317, WO 99/67425, WO 99/37819, WO 00/38836, PCT U.S. 00/19889 and WO 99/57319.

Heller et al. (in U.S. Pat. Nos. 5,605,662 and 5,632,957) provide methods for controlling molecular biological reactions in microscopic formats that utilize a self-addressable, self-assembling microelectronic apparatus. Heller et al. further provide an apparatus in which target molecules labeled with fluorescent dyes are transported by free field electrophoresis to specific test sites where the target molecules are concentrated thereby, and reacted with specific probes bound to that test site. Unbound or non-specifically interacting target molecules are thereafter removed by reversing the electric polarity at the test site. Interactions between probe and target molecules are subsequently assayed using optical means.

Certain alternative methods that do not employ labeled target nucleic acids have been described in the prior art. For example, Hollis et al. (in U.S. Pat. Nos. 5,653,939 and 5,846,708) provide a method and apparatus for identifying molecular structures within a sample substance using a monolithic array of test sites formed on a substrate upon which the sample substance is applied In the method of Hollis et al., changes in the electromagnetic or acoustic properties—for example, the change in resonant frequency—of the test sites following the addition of the sample substance are detected in order to determine which probes have interacted with target molecules in the sample substance.

In addition, Eggers et a. (in U.S. Pat. Nos. 5,532,128, 5,670,322, and 5,891,630) provide a method and apparatus for identifying molecular structures within a sample substance. In the method of Eggers et al., a plurality of test sites to which probes have been bound is exposed to a sample substance and then an electrical signal is applied to the test sites. The dielectrical properties of the test sites are subsequently detected to determine which probes have interacted with target molecules in the sample substance.

Another obstacle in the development of a simple and cost-effective electrical and electrochemical detection apparatus for detecting molecular interactions involves the attachment of probe molecules to the microelectrodes or substrate of a microarray. For example, although the prior art provides microarrays using polyacrylamide pads for attachment of oligonucleotide probes to a solid support, the art has not provided such pads in conjunction with an electrical or electrochemical detection apparatus.

Guschin et al., 1997, Anal. Biochem. 250: 203-11 describe a technique for detecting molecular interactions between target molecules in a biological sample solution and polyacrylamide gel-immobilized probes on a glass substrate. In the technique disclosed by Guschin et al., molecular interactions between probes and target molecules are detected using optical reporters. The Guschin et al. reference neither teaches nor suggests using electrical or electrochemical detection techniques to detect hybridization between target molecules and immobilized probes.

Guschin et al., 1997, Appl. Environ. Microbiol. 63: 2397-402 also describe the fabrication of microarrays through the immobilization of oligonucleotide probes on a polyacrylamide gel pad placed in contact with a glass substrate. In this technique disclosed by Guschin et al., parallel hybridization between target nucleic acids and immobilized probes is detected using optical reporter moieties. This Guschin et al. reference also does not teach or suggest using electrical or electrochemical detection techniques in combination with the immobilization of probes on polyacrylamide gel pads.

In addition, Yang et al., 1997, Anal. Chim. Acta 346: 259-75 describe the fabrication of microarrays through the immobilization of nucleic acid probes on polyacrylamide gel pads and subsequent detection of molecular interactions between probe and target molecules using optical reporter moieties. Yang et al. further describe an alternative technique in which molecular interactions between labeled target molecules and nucleic acid probes that have been directly attached to solid electrodes are detected using electrical or electrochemical means. Yang et al., however, does not suggest using electrical or electrochemical detection techniques in combination with the immobilization of probes on polyacrylamide gel pads.

The detection of single base mutations and genetic polymorphisms in nucleic acids is an important tool in modern diagnostic medicine and biological research. In addition, nucleic acid-based assays also play an important role in identifying infectious microorganisms such as bacteria and viruses, in assessing levels of both normal and defective gene expression, and in detecting and identifying mutant genes associated with disease such as oncogenes. Improvements in the speed, efficiency, economy and specificity of such assays are thus significant needs in the medical arts.

Ideally, such assays should be sensitive, specific and easily amenable to automation. Efforts to improve sensitivity in nucleic acid assays are known in the prior art. For example, the polymerase chain reaction (Mullis, U.S. Pat. No. 4,683,195, issued Jul. 28, 1987) provides the capacity to produce useful amounts (about 1 μg) of a specific nucleic acid in a sample in which the original amount of the specific nucleic acid is substantially smaller (about 1 pg). However, the prior art has been much less successful in improving specificity of nucleic acid hybridization assays.

The specificity of nucleic acid assays is determined by the extent of molecular complementarity of hybridization between probe and target sequences. Although it is theoretically possible to distinguish complementary targets from one or two mismatched targets under rigorously-defined conditions, the dependence of hybridization on target/probe concentration and hybridization conditions limits the extent to which hybridization mismatch can be used to reliably detect, inter alia. mutations and genetic polymorphisms.

Detection of single base extension has been used for mutation and genetic polymorphism detection in the prior art.

U.S. Pat. No. 5,925,520 disclosed a method for detecting genetic polymorphisms using single base extension and capture groups on oligonucleotide probes using at least two types of dideoxy, chain-terminating nucleotide triphosphates, each labeled with a detectable and distinguishable fluorescent labeling group.

U.S. Pat. No. 5,710,028 disclosed a method of determining the identity of nucleotide bases at specific positions in nucleic acids of interest, using detectably-labeled chain-terminating nucleotides, each detectably and distinguishably labeled with a fluorescent labeling group.

U.S. Pat. No. 5,547,839 disclosed a method for determining the identity of nucleotide bases at specific positions in a nucleic acid of interest, using chain-terminating nucleotides comprising a photoremovable protecting group.

U.S. Pat. No. 5,534,424 disclosed a method for determining the identity of nucleotide bases at specific positions in a nucleic acid of interest, using each of four aliquots of a target nucleic acid annealed to an extension primer and extended with one of four chain-terminating species, and then further extended with all four chain-extending nucleotides, whereby the identity of the nucleotide at the position of interest is identified by failure of the primer to be extended more that a single base.

U.S. Pat. No. 4,988,617 disclosed a method for determining the identity of nucleotide bases at specific positions in a nucleic acid of interest, by annealing two adjacent nucleotide primers to a target nucleic acid and providing a linking agent such as a ligase that covalently links the two oligonucleotides to produce a third, combined oligonucleotide only under circumstances wherein the two oligonucleotides are perfectly matched to the target nucleic acid at the 3′ extent of the first oligonucleotide and at the 5′ extent of the second oligonucleotide.

U.S. Pat. No. 4,656,127 disclosed a method for determining the identity of nucleotide bases at specific positions in a nucleic acid of interest, using primer extension with a chain-terminating or other nucleotide comprising an exonuclease-resistant linkage, followed by exonuclease treatment of the plurality of extension products to detect the resistant species therein.

One common feature in this prior art is that single base extension has been detected by incorporation of fluorescent labels into the extended nucleic acid species.

A significant drawback of single base extension methods based on fluorescent label detection is the need for expensive and technically-complex optical components for detecting the fluorescent label. Although fluorescent probes used in such methods impart an adequate level of discrimination between extended and unextended positions in an oligonucleotide array, these methods typically require detection of up to four different fluorescent labels, each having a unique excitation and fluorescence emission frequency. As a consequence of these properties, such assay systems must be capable of producing and distinguishing light at all of these different excitation and emission frequencies, significantly increasing the cost and complexity of producing and operating apparatus used in the practice thereof.

An alternative method for detecting a target nucleic acid molecule is to use an electrochemical tag (or label) such as a redox moiety in combination with an electrochemical detection means such as cyclic voltammetry, some of which are discussed above.

In addition, disclosure of similar methods for detecting biological molecules such as DNA and proteins can be found in Ihara et al., 1996, Nucleic Acids Res. 24: 4273-4280; Livache et al., 1995, Synthetic Metals 71: 2143-2146; Hashimoto, 1993, Supramolecular Chem. 2: 265-270; Millan et al., 1993, Anal. Chem. 65: 2317-2323.

However, most of the electrochemical tag-dependent methods known in the prior art require hybridization of the probe/target in the presence of a redox intercalator. Electrochemical detection based on redox intercalators are generally not as reproducible as redox tags that are covalently bound to an incorporated moiety. Redox intercalator methods are exceedingly dependent on washing conditions to remove excess label while not reducing the actual signal. As a consequence, false positives are often obtained using these methods. The specificity of redox intercalator methods is often much worse than can be achieved with covalently-bound redox tags.

There remains a need in this art for simple, economical, and efficient ways to detect single base extension products of nucleic acid assays for detecting mutation and genetic polymorphisms in biological samples containing a nucleic acid of interest.

Similarly, there remains a need in the art to develop alternatives to current detection methods used to detect interactions between biological molecules, particularly nucleic acids and peptides. In particular, there is a need in the art to develop electrical or electrochemical methods for detecting interactions between biological molecules that do not require modifying target or probe molecules with reporter labels. The development of such methods has wide applications in the medical, genetic, and molecular biological arts. There further remains a need in the art to develop alternatives for the attaching such biological molecules to the microelectrodes or substrate of an electrical or electrochemical device.

### SUMMARY OF THE INVENTION

The present invention provides an apparatus and methods, using cations in an electrolyte solution, for detecting the nature and extent of molecular interactions between probe and target molecules. The most preferred embodiments of the methods of the invention utilize AC impedance for said detection. The apparatus and methods of the present invention have the advantage of providing electrical detection without any additional requirement that the target molecule be labeled with a reporter molecule.

In preferred embodiments of the present invention, the apparatus and methods are useful for detecting molecular interactions such as nucleic acid hybridization between oligonucleotide probe molecules bound to defined regions of an ordered array and nucleic acid target molecules which are permitted to interact with the probe molecules. In other embodiments of the present invention, the apparatus and methods are useful for detecting interactions between peptides (e.g., receptor-ligand binding or antibody recognition of antigens).

In more preferred embodiments, the apparatus of the present invention comprises a supporting substrate, an array of microelectrodes in contact with the supporting substrate to which probes are immobilized, at least one counter-electrode in electrochemical contact with the supporting substrate, a means for producing electrical impedance at each microelectrode, a means for detecting changes in impedance at each microelectrode in the presence or absence of a target molecule, and an electrolyte solution in contact with the plurality of microelectrodes.

In alternative preferred embodiments, the apparatus of the present invention comprises a supporting substrate, an array of microelectrodes in contact with the supporting substrate, a plurality of polyacrylamide gel pads in contact with microelectrodes and to which probes are immobilized, at least one counter-electrode in electrochemical contact with the supporting substrate, a means for producing electrical impedance at each microelectrode, a means for detecting changes in impedance at each microelectrode in the presence or absence of a target molecule, and an electrolyte solution in contact with the plurality of microelectrodes. Alternatively, multiple electrodes can be defined on a substrate and covered with a continuous, unpatterned layer of polyacrylamide or other polymer.

In preferred embodiments of the present invention, microelectrodes are prepared from, but not limited to, metals such as dense or porous films of gold, platinum, titanium, or copper, metal oxides, metal nitrides, metal carbides, or carbon.

In a preferred embodiment of the invention, the electrolyte solution comprises metal cations or polymerized cations that are ion conductive and capable of reacting with probes or probe-target complexes. In a more preferred embodiment, the electrolyte solution comprises a salt of a lithium cation, most preferably LiClO₄.

The apparatus of the present invention may further comprise at least one reference electrode. In an alternative embodiment of the present invention, the apparatus further comprises a plurality of wells each of which encompasses at least one microelectrode and at least one counter-electrode that is sufficient to interrogate the entire array.

In a preferred method of the present invention, an electrolyte solution as described above is placed in contact with a plurality of microelectrodes to which nucleic acid probes have been immobilized, preferably having a neutral polypyrrole layer there between. AC impedance of the microelectrodes is first measured in the absence of added target nucleic acid. Thereafter, the microelectrodes are contacted with a biological sample substance containing target nucleic acid molecules, most preferably by adding the sample to the electrolyte solution or replacing the electrolyte solution with the sample contained in or diluted in the electrolyte solution. The probes and target molecules are allowed to interact, preferably by hybridization, and the AC impedance measured thereafter.

In another embodiment of the methods of the present invention, an electrolyte solution as described above is placed in contact with a plurality of microelectrodes and polyacrylamide gel pads to which nucleic acid probes have been immobilized. AC impedance of the microelectrodes is first measured in the absence of added target nucleic acid. Thereafter, the microelectrodes are contacted with a biological sample substance containing target nucleic acid molecules, most preferably by adding the sample to the electrolyte solution or replacing the electrolyte solution with the sample contained in or diluted in the electrolyte solution. The probes and target molecules are allowed to interact, preferably by hybridization, and the AC impedance measured thereafter.

In a preferred embodiment of the methods of the present invention, the AC impedance is measured at different frequencies in order to increase the sensitivity of the method. Probe-target interactions are detected by differences in the AC impedance signals at individual microelectrodes before and after such interactions. Most preferably, the method is used to discern the difference between hybridization between an immobilized oligonucleotide probe on a microelectrode and a complimentary target nucleic acid (“complete” hybridization), and hybridization between the immobilized oligonucleotide and a mismatched target nucleic acid (“mismatch” hybridization). Information about the nucleotide sequence of the oligonucleotides immobilized at each microelectrode is then used in conjunction with “complete” or “mismatch” hybridization as detected by the method of the invention to determine the presence or absence of a particular target nucleic acid in the sample.

In an alternate embodiment, the present invention provides an apparatus and methods for the electric or electrochemical detection of the nature and extent of molecular interactions between probe molecules and electrochemically active reporter-labeled target molecules. In preferred embodiments of the present invention, the apparatus and methods are useful for detecting molecular interactions such as nucleic acid hybridization between oligonucieotide probe molecules bound to defined regions of an ordered array and electrochemically active reporter-labeled nucleic acid target molecules which are permitted to interact with the probe molecules. In other embodiments of the present invention, the apparatus and methods are useful for detecting interactions between peptides (e.g., receptor-ligand binding or antibody recognition of antigens).

In more preferred embodiments, the apparatus of the present invention comprises a supporting substrate, an array of microelectrodes in contact with the supporting substrate, a plurality of polymeric hydrogel pads in contact with the microelectrodes and to which probes are immobilized, at least one counter-electrode in electrochemical contact with the supporting substrate, a means for producing an electrical signal at each microelectrode, a means for detecting changes in the electrical signal at each microelectrode in the presence or absence of an electrochemically active reporter-labeled target molecule, and a electrolyte solution in contact with the plurality of hydrogel porous microelectrodes and counter-electrode. Alternatively, multiple electrodes can be defined on a substrate and covered with a continuous, unpatterned layer of polymeric hydrogel.

In preferred embodiments of the present invention, microelectrodes are prepared from metals such as dense or porous films of gold, platinum, titanium, or copper, metal oxides, metal nitrides, metal carbides, or graphite carbon.

In some embodiments of the present invention, the probes are oligonucleotide probes having a sequence comprising from about 10 to about 100 nucleotide residues, and said probes are attached to the polyacrylamide gel pads using techniques known to those with skill in the art. In other embodiments, the probes are peptides, such as receptors, ligands, antibodies, antigens, or synthetic peptides, and said probes are attached to the polymeric hydrogel pads using techniques known to those with skill in the art.

The apparatus of the present invention may further comprise at least one reference electrode. In an alternative embodiment of the present invention, the apparatus further comprises a plurality of wells each of which encompasses at least one hydrogel porous microelectrode and at least one counter-electrode that is sufficient to interrogate the entire array.

In the method of the present invention, molecular interactions between probe molecules and electrochemically active reporter-labeled target molecules are detected by applying conventional electric or electrochemical detection methods, such as, for example, AC impedance. In one embodiment, the AC impedance of a plurality of hydrogel porous microelectrodes to which nucleic acid probes have been immobilized is first measured in the absence of an electrochemically-labeled target nucleic acid. Thereafter, the hydrogel porous microelectrodes are contacted with a biological sample substance containing electrochemically active reporter-labeled target molecules. The probes and target molecules are allowed to interact, preferably by hybridization, and AC impedance measured thereafter.

In a preferred embodiment of the methods of the present invention, the AC impedance is measured at different frequencies in order to increase the sensitivity of the method. Interactions between probe molecules and electrochemically-labeled target molecules are detected by differences in the AC impedance signals at individual hydrogel porous microelectrodes before and prior to such interactions. Most preferably, the method is used to discern the difference between hybridization between an immobilized oligonucleotide probe on a hydrogel porous microelectrode and a complimentary target nucleic acid (“complete” hybridization), and hybridization between the immobilized oligonucleotide and a mismatched target nucleic acid (“mismatch” hybridization). Information about the nucleotide sequence of the oligonucleotides immobilized at each hydrogel porous microelectrode is then used in conjunction with “complete” or “mismatch” hybridization as detected by the method of the invention to determine the presence or absence of a particular target nucleic acid in the sample.

In other embodiments of the present invention, other electric and/or electrochemical methods can be used to detect molecular interactions between probe molecules and electrochemically-labeled target molecules, including, but not limited to, cyclic voltammetry, stripping voltammetry, pulse voltammetry, square wave voltammetry, AC voltammetry, hydrodynamic modulation voltammetry, potential step method, potentiometric measurements, amperometric measurements, current step method, and combinations thereof.

The invention further comprises methods and apparatus for detecting mutations and genetic polymorphisms in a biological sample containing a nucleic acid of interest. Detection of single base extension using the methods and apparatus of the invention is achieved by sequence-specific incorporation of chain-terminating nucleotide species chemically labeled with an electrochemical species. In preferred embodiments, single base extension is performed using hybridization to an oligonucleotide array, most preferably an addressable array wherein the sequence of each oligonucleotide in the array is known and associated with a particular address in the array. In additional preferred embodiments, single base extension is detected using extension products labeled with electrochemical reporter groups, wherein the electrochemical reporter groups comprise a transition metal complex, most preferably containing a transition metal ion that is ruthenium, cobalt, iron or osmium.

In the practice of the methods of the invention, the invention provides an array of oligonucleotide probes immobilized to a surface that defines a first electrode. Preferably, the sequence of each oligonucleotide at each particular identified position (or “address”) in the array is known and at least one of said oligonucleotides is complementary to a sequence in a nucleic acid contained in the biological sample to be assayed (termed the “target” or “target nucleic acid”). In one preferred embodiment, the sequence of at least one oligonucleotide is selected to hybridize to a position immediately adjacent to the nucleotide position in the sample nucleic acid that is to be interrogated, i.e., for mutation or genetic polymorphism. The term “adjacent” in this context is intended to encompass positions that are one nucleotide base upstream of base to be interrogated, i.e. in the 3′ direction with respect to the template strand of the target DNA. Hybridization of the oligonucleotides in the array to nucleic acid in the sample is performed in a reaction chamber and in a hybridization buffer for a time and at a temperature that permits hybridization to occur between nucleic acid in the sample and the oligonucleotides in the array complementary thereto. Single base extension is performed using a polymerase, most preferably a thermally stable polymerase, in the presence of chain-terminating primer extension units that are covalently linked to an electrochemical label. In a preferred embodiment, each chain-terminating nucleotide species (for example, dideoxy(dd)ATP, ddGTP, ddCTP and ddTTP) is labeled with a different electrochemical label, most preferably having a different, distinct and differentially-detectable reduction/oxidation potential. Single base extension is detected by applying conventional electrochemical detection methods, such as cyclic voltammetry or stripping voltammetry. Other electric or/and electrochemical methods that may also be used, include, but are not limited to, AC impedance, pulse voltammetry, square wave voltammetry, AC voltammetry (ACV), hydrodynamic modulation voltammetry, potential step method, potentiometric measurements, amperometric measurements, current step method, and combinations thereof.

In alternative embodiments, the sequence of at least one oligonucleotide is selected to hybridize to the target nucleic acid at a position whereby the 3′ residue of the oligonucleotide hybridizes to the nucleotide position in the sample nucleic acid that is to be interrogated for mutation or genetic polymorphism. In the array, oligonucleotides having sequence identity to the oligonucleotide that hybridizes to the target nucleic acid at it's 3′ residue will also hybridize to the target, but the 3′ residue of such oligonucleotides will produce a “mismatch” with the target and will not hybridize at the 3′ residue. Single base extension is performed with a polymerase that will not recognize the mismatch, so that only the oligonucleotide that hybridizes to the target including at its 3′ residue will be extended. In these embodiments of the invention, only a single chain-terminating species labeled with an electrochemical species can be employed, or the same electrochemical species can be used for all four chain-terminating species, provided that the nucleotide sequence of each oligonucleotide in the array is known and properly associated with its position in the array. The detection of an electrochemical signal from the redox species using conventional electrochemical detection methods, such as cyclic voltammetry, at a particular position in the array thus provides the identity of the 3′ residue of the probe and hence the identity of the complementary nucleotide at the corresponding position in the target nucleic acid.

In the practice of a preferred embodiment of the methods and use of the apparatus of the invention, electric current is recorded as a function of sweeping voltage to the first electrode specific for each particular chain-terminating nucleotide species labeled with an electrochemically-active reporter. In preferred embodiments, current flow at each specific potential is detected at each address in the array where single base extension has occurred with the corresponding chain-terminating nucleotide species labeled with a particular electrochemical reporter group. The detection of the electrical signal at a particular position in the array wherein the nucleotide sequence of the oligonucleotide occupying that position is known enables the identity of the extended nucleotide, and therefore the mutation or genetic polymorphism, to be determined.

### BRIEF DESCRIPTION OF THE DRAWINGS

FIGS. 1A and 1B illustrate a schematic representation of the structure of a hydrogel porous microelectrode (FIG. 1A) and a schematic representation of the structure of the tip of a hydrogel porous microelectrode (FIG. 1B);

FIGS. 2A and 2B illustrate the electrochemical oxidation of pyrrole (FIG. 2A) and the neutralization of polypyrrole (FIG. 2B);

FIGS. 3A and 3B illustrate the Frequency Complex curves obtained from polypyrrole microelectrodes before and after the hybridization of a 15-mer oligonucleotide probe and complementary nucleic acid target molecule (FIG. 3A) and the Frequency Complex curve obtained in the high frequency zone from polypyrrole microelectrodes before and after the hybridization of a 15-mer oligonucleotide probe and complementary target molecule (FIG. 3B);

FIGS. 4A and 4B illustrate a plot of low frequency resistance versus w^{-1/2} (FIG. 4A) and the plot of high frequency resistance versus w^{-1/2} (FIG. 4B);

FIGS. 5A and 5B illustrate the Frequency Complex curve obtained for the hybridization of an oligonucleotide probe and a fully complementary nucleic acid target molecule (FIG. 5A) and the Frequency Complex curve obtained for the hybridization of an oligonucleotide probe and a nucleic acid target molecule possessing three mismatches (FIG. 5B; curve 1 was obtained before hybridization of the target molecule to the probe, curve 2 was obtained following hybridization of probe and target molecules for 48 hours, curve 3 was obtained following washing of hybridized molecules for 30 min. at 37° C., and curve 4 was obtained following washing of hybridized molecules for 30 min. at 38° C.);

FIG. 6 illustrates a plot of low frequency resistance versus w^{-1/2} obtained for the hybridization of an oligonucleotide probe and a nucleic acid target molecule possessing three mismatches (curve 1 was obtained before hybridization of the target molecule to the probe, curve 2 was obtained following hybridization of probe and target molecules for 48 hours, curve 3 was obtained following washing of hybridized molecules for 30 min. at 37° C., and curve 4 was obtained following washing of hybridized molecules for 30 min. at 38° C.)

FIG. 7 illustrates the Frequency Complex curve obtained from polypyrrole microelectrodes before and after the hybridization of a 15-mer oligonucleotide probe and complementary nucleic acid target molecule in an electrolyte containing 0.1 M LiClO₄;

FIGS. 8A through 8C illustrate a schematic representation of the circuit (FIG. 8A), the AC impedance response for a polypyrrole microelectrode with an attached single-strand nucleic acid probe before hybridization to a target molecule (FIG. 8B), and a schematic representation of the circuit for a polypyrrole microelectrode with an attached single-strand nucleic acid probe after hybridization to a target molecule (FIG. 8C);

FIG. 9 illustrates a plot of capacitance versus frequency for a polypyrrole microelectrode with an attached single-strand nucleic acid probe after hybridization to a target molecule;

FIG. 10 illustrates a plot of resistance versus frequency for a polypyrrole microelectrode with an attached single-strand nucleic acid probe after hybridization to a target molecule;

FIG. 11 illustrates a hydrogel porous microelectrode;

FIG. 12 illustrates the Frequency Complex curves obtained from a hydrogel porous microelectrode with attached 15-mer oligonucleotide probe in the absence of a complementary target molecule (curve 1), following incubation with 2 pM of a complementary target molecule (curve 2), and following incubation with 300 nM of a mismatched target molecule (curve 3);

FIG. 13 illustrates a plot of capacitance versus frequency for a hydrogel porous microelectrode with an attached single-strand nucleic acid probe after hybridization to a target molecule;

FIG. 14 illustrates a plot of resistance versus frequency for a hydrogel porous microelectrode with an attached single-strand nucleic acid probe after hybridization to a target molecule.

FIG. 15 illustrates single base extension using chain-terminating nucleotdie species labeled with an electrochemical reporter group (ECA label).

### DETAILED DESCRIPTION OF THE INVENTION

The present invention is directed to a variety of electronic and electrochemical techniques that may be used to detect the presence of target analytes, particularly nucleic acids, in samples. The methods generally rely on the molecular interactions such as nucleic acid hybridization or protein-protein binding reactions done on solid supports with arrays of capture binding ligands. As a result of these interactions, some electronic property of the system changes, and detection is achieved.

This may be done in a variety of ways. In a preferred embodiment, the methods of the invention utilize AC impedance for the detection. In some embodiments, the apparatus and methods of the present invention have the advantage of providing electrical detection without any additional requirement that the target molecule be labeled with a reporter molecule. That is, the electrical impedance of the system changes as a result of the specific binding of a target analyte to its corresponding capture binding ligand (frequently referred to herein as “capture probes” when the analyte is a nucleic acid).

Alternatively, the use of electrochemically active labels allows the detection of specific interactions, in a manner similar to known fluorescent systems. In this embodiment, either the target can be labeled with an electrochemically active (ECA) label, for example during an amplification reaction such as PCR when the target is a nucleic acid, or through the use of secondary labeling systems.

In a preferred embodiment, when the target is a nucleic acid, these ECA labels are exploited to allow the identification of specific bases within a target sequence, as is generally outlined below.

The methods and compositions of the invention are used to detect target analytes in samples. By “target analyte” or “analyte” or grammatical equivalents herein is meant any molecule, compound or particle to be detected. As outlined below, target analytes preferably bind to binding ligands, as is more fully described above. As will be appreciated by those in the art, a large number of analytes may be detected using the present methods; basically, any target analyte for which a binding ligand, described herein, may be made may be detected using the methods of the invention.

Suitable analytes include organic and inorganic molecules, including biomolecules. In a preferred embodiment, the analyte may be an environmental pollutant (including pesticides, insecticides, toxins, etc.); a chemical (including solvents, polymers, organic materials, etc.); therapeutic molecules (including therapeutic and abused drugs, antibiotics, etc.); biomolecules (including hormones, cytokines, proteins, lipids, carbohydrates, cellular membrane antigens and receptors (neural, hormonal, nutrient, and cell surface receptors) or their ligands, etc); whole cells (including procaryotic (such as pathogenic bacteria) and eukaryotic cells, including mammalian tumor cells); viruses (including retroviruses, herpesviruses, adenoviruses, lentiviruses, etc.); and spores; etc. Particularly preferred analytes are environmental pollutants; nucleic acids; proteins (including enzymes, antibodies, antigens, growth factors, cytokines, etc); therapeutic and abused drugs; cells; and viruses.

In a preferred embodiment, the target analyte is a nucleic acid. By “nucleic acid” or “oligonucleotide” or grammatical equivalents herein means at least two nucleotides covalently linked together. A nucleic acid of the present invention will generally contain phosphodiester bonds, although in some cases, as outlined below, nucleic acid analogs are included that may have alternate backbones, comprising, for example, phosphoramide (Beaucage et al., Tetrahedron 49(10):1925 (1993) and references therein; Letsinger, J. Org. Chem. 35:3800 (1970); Sprinzl et al., Eur. J. Biochem. 81:579 (1977); Letsinger et al., Nucl. Acids Res. 14:3487 (1986); Sawai et al, Chem. Lett. 805 (1984), Letsinger et al., J. Am. Chem. Soc. 110:4470 (1988); and Pauwels et al., Chemica Scripta 26:141 91986)), phosphorothioate (Mag et al., Nucleic Acids Res. 19:1437 (1991); and U.S. Pat. No. 5,644,048), phosphorodithioate (Briu et al., J. Am. Chem. Soc. 111:2321 (1989), O-methylphophoroamidite linkages (see Eckstein, Oligonucleotides and Analogues: A Practical Approach, Oxford University Press), and peptide nucleic acid backbones and linkages (see Egholm, J. Am. Chem. Soc. 114:1895 (1992); Meier et al., Chem. Int. Ed. Engl. 31:1008 (1992); Nielsen, Nature, 365:566 (1993); Carlsson et al., Nature 380:207 (1996), all of which are incorporated by reference). Other analog nucleic acids include those with positive backbones (Denpcy et al., Proc. Natl. Acad. Sci. USA 92:6097 (1995); non-ionic backbones (U.S. Pat. Nos. 5,386,023, 5,637,684, 5,602,240, 5,216,141 and 4,469,863; Kiedrowshi et al., Angew Chem. Intl. Ed. English 30:423 (1991); Letsinger et al., J. Am. Chem. Soc. 110:4470 (1988); Letsinger et al., Nucleoside & Nucleotide 13:1597 (1994); Chapters 2 and 3, ASC Symposium Series 580, “Carbohydrate Modifications in Antisense Research”, Ed. Y. S. Sanghui and P. Dan Cook; Mesmaeker et al., Bioorganic & Medicinal Chem. Lett. 4:395 (1994); Jeffs et al., J. Biomolecular NMR 34:17 (1994); Tetrahedron Lett. 37:743 (1996)) and non-ribose backbones, including those described in U.S. Pat. Nos. 5,235,033 and 5,034,506, and Chapters 6 and 7, ASC Symposium Series 580, “Carbohydrate Modifications in Antisense Research”, Ed. Y. S. Sanghui and P. Dan Cook. Nucleic acids containing one or more carbocyclic sugars are also included within the definition of nucleic acids (see Jenkins et al., Chem. Soc. Rev. (1995) pp169-176). Several nucleic acid analogs are described in Rawls, C & E News Jun. 2, 1997 page 35. Nucleic acid analogs also include “locked nucleic acids”. All of these references are hereby expressly incorporated by reference. These modifications of the ribose-phosphate backbone may be done to facilitate the addition of electron transfer moieties, or to increase the stability and half-life of such molecules in physiological environments.

As will be appreciated by those in the art, all of these nucleic acid analogs may find use in the present invention. In addition, mixtures of naturally occurring nucleic acids and analogs can be made; for example, at the site of conductive oligomer or electron transfer moiety attachment, an analog structure may be used. Alternatively, mixtures of different nucleic acid analogs, and mixtures of naturally occurring nucleic acids and analogs may be made.

As outlined herein, the nucleic acids may be single stranded or double stranded, as specified, or contain portions of both double stranded or single stranded sequence. The nucleic acid may be DNA, both genomic and cDNA, RNA or a hvbrid, where the nucleic acid contains any combination of deoxyribo- and ribo-nucleotides, and any combination of bases, including uracil, adenine, thymine, cytosine, guanine, inosine, xathanine hypoxathanine, isocytosine, isoguanine, etc. As used herein, the term “nucleoside” includes nucleotides and nucleoside and nucleotide analogs, and modified nucleosides such as amino modified nucleosides. In addition, “nucleoside” includes non-naturally occuring analog structures. Thus for example the individual units of a peptide nucleic acid, each containing a base, are referred to herein as nucleosides.

In a preferred embodiment, the present invention provides methods of detecting target nucleic acids. By “target nucleic acid” or “target sequence” or grammatical equivalents herein means a nucleic acid sequence on a single strand of nucleic acid. The target sequence may be a portion of a gene, a regulatory sequence, genomic DNA, cDNA, RNA including mRNA and rRNA, or others. It may be any length, with the understanding that longer sequences are more specific. In some embodiments, it may be desirable to fragment or cleave the sample nucleic acid into fragments of 100 to 10,000 basepairs, with fragments of roughly 500 basepairs being preferred in some embodiments. As will be appreciated by those in the art, the complementary target sequence may take many forms. For example, it may be contained within a larger nucleic acid sequence, i.e. all or part of a gene or mRNA, a restriction fragment of a plasmid or genomic DNA, among others.

As is outlined more fully below, probes (including primers) are made to hybridize to target sequences to determine the presence or absence of the target sequence in a sample. Generally speaking, this term will be understood by those skilled in the art.

The target sequence may also be comprised of different target domains, which may be adjacent (i.e. contiguous) or separated. For example, when ligation chain reaction (LCR) techniques are used, a first primer may hybridize to a first target domain and a second primer may hybridize to a second target domain; either the domains are adjacent, or they may be separated by one or more nucleotides, coupled with the use of a polymerase and dNTPs, as is more fully outlined below. The terms “first” and “second” are not meant to confer an orientation of the sequences with respect to the 5′-3′ orientation of the target sequence. For example, assuming a 5′-3′ orientation of the complementary target sequence, the first target domain may be located either 5′ to the second domain, or 3′ to the second domain.

In a preferred embodiment, the target analyte is a protein. As will be appreciated by those in the art, there are a large number of possible proteinaceous target analytes that may be detected using the present invention. By “proteins” or grammatical equivalents herein is meant proteins, oligopeptides and peptides, derivatives and analogs, including proteins containing non-naturally occurring amino acids and amino acid analogs, and peptidomimetic structures. The side chains may be in either the (R) or the (S) configuration. In a preferred embodiment, the amino acids are in the (S) or L-configuration. As discussed below, when the protein is used as a binding ligand, it may be desirable to utilize protein analogs to retard degradation by sample contaminants.

Suitable protein target analytes include, but are not limited to, (1) immunoglobulins, particularly IgEs, IgGs and IgMs, and particularly therapeutically or diagnostically relevant antibodies, including but not limited to, for example, antibodies to human albumin, apolipoproteins (including apolipoprotein E), human chorionic gonadotropin, cortisol, α-fetoprotein, thyroxin, thyroid stimulating hormone (TSH), antithrombin, antibodies to pharmaceuticals (including antieptileptic drugs (phenytoin, primidone, carbariezepin, ethosuximide, valproic acid, and phenobarbitol), cardioactive drugs (digoxin, lidocaine, procainamide, and disopyramide), bronchodilators (theophylline), antibiotics (chloramphenicol, sulfonamides), antidepressants, immunosuppresants, abused drugs (amphetamine, methamphetamine, cannabinoids, cocaine and opiates) and antibodies to any number of viruses (including orthomyxoviruses, (e.g. influenza virus), paramyxoviruses (e.g respiratory syncytial virus, mumps virus, measles virus), adenoviruses, rhinoviruses, coronaviruses, reoviruses, togaviruses (e.g. rubella virus), parvoviruses, poxviruses (e.g. variola virus, vaccinia virus), enteroviruses (e.g. poliovirus, coxsackievirus), hepatitis viruses (including A, B and C), herpesviruses (e.g. Herpes simplex virus, varicella-zoster virus, cytomegalovirus, Epstein-Barr virus), rotaviruses, Norwalk viruses, hantavirus, arenavirus, rhabdovirus (e.g. rabies virus), retroviruses (including HIV, HTLV-I and -II), papovaviruses (e.g. papillomavirus), polyomaviruses, and picornaviruses, and the like), and bacteria (including a wide variety of pathogenic and non-pathogenic prokaryotes of interest including Bacillus; Vibrio, e.g. V. cholerae; Escherichia, e.g. Enterotoxigenic E. coli, Shigella, e.g. S. dysenteriae; Salmonella, e.g. S. typhi; Mycobacterium e.g. M. tuberculosis, M. leprae; Clostridium, e.g. C. botulinum, C. tetani, C. difficile, C.perfringens; Cornyebacterium, e.g. C. diphtheriae; Streptococcus, S. pyogenes. S. pneumoniae; Staphylococcus, e.g. S. aureus; Haemophilus, e.g. H. influenzae; Neisseria, e.g. N. meningitidis, N. gonorrhoeae; Yersinia, e.g. G. lamblia Y. pestis, Pseudomonas, e.g. P. aeruginosa, P. putida; Chlamydia, e.g. C. trachomatis; Bordetella, e.g. B. pertussis; Treponema, e.g. T. palladium; and the like); (2) enzymes (and other proteins), including but not limited to, enzymes used as indicators of or treatment for heart disease, including creatine kinase, lactate dehydrogenase, aspartate amino transferase, troponin T, myoglobin, fibrinogen, cholesterol, triglycerides, thrombin, tissue plasminogen activator (tPA); pancreatic disease indicators including amylase, lipase, chymotrypsin and trypsin; liver function enzymes and proteins including cholinesterase, bilirubin, and alkaline phosphotase; aldolase, prostatic acid phosphatase, terminal deoxynucleotidyl transferase, and bacterial and viral enzymes such as HIV protease; (3) hormones and cytokines (many of which serve as ligands for cellular receptors) such as erythropoietin (EPO), thrombopoietin (TPO), the interleukins (including IL-1 through IL-17), insulin, insulin-like growth factors (including IGF-1 and -2), epidermal growth factor (EGF), transforming growth factors (including TGF-α and TGF-β), human growth hormone, transferrin, epidermal growth factor (EGF), low density lipoprotein, high density lipoprotein, leptin, VEGF, PDGF, ciliary neurotrophic factor, prolactin, adrenocorticotropic hormone (ACTH), calcitonin, human chorionic gonadotropin, cotrisol, estradiol, follicle stimulating hormone (FSH), thyroid-stimulating hormone (TSH), leutinzing hormone (LH), progeterone and testosterone; and (4) other proteins (including α-fetoprotein, carcinoembryonic antigen CEA, cancer markers, etc.).

In addition, any of the biomolecules for which antibodies may be detected may be detected directly as well; that is, detection of virus or bacterial cells, therapeutic and abused drugs, etc., may be done directly.

Suitable target analytes include carbohydrates, including but not limited to, markers for breast cancer (CA15-3, CA 549, CA 27.29), mucin-like carcinoma associated antigen (MCA), ovarian cancer (CA125), pancreatic cancer (DE-PAN-2), prostate cancer (PSA), CEA, and colorectal and pancreatic cancer (CA 19, CA 50, CA242).

Suitable target analytes include metal ions, particularly heavy and/or toxic metals, including but not limited to, aluminum, arsenic, cadmium, selenium, cobalt, copper, chromium, lead, silver and nickel.

These target analytes may be present in any number of different sample types, including, but not limited to, bodily fluids including blood, lymph, saliva, vaginal and anal secretions, urine, feces, perspiration and tears, and solid tissues, including liver, spleen, bone marrow, lung, muscle, brain, etc.

Accordingly, the present invention provides devices for the detection of target analytes comprising a solid substrate. The solid substrate can be made of a wide variety of materials and can be configured in a large number of ways, as is discussed herein and will be apparent to one of skill in the art. In addition, a single device may be comprises of more than one substrate; for example, there may be a “sample treatment” cassette that interfaces with a separate “detection” cassette; a raw sample is added to the sample treatment cassette and is manipulated to prepare the sample for detection, which is removed from the sample treatment cassette and added to the detection cassette. There may be an additional functional cassette into which the device fits; for example, a heating element which is placed in contact with the sample cassette to effect reactions such as PCR. In some cases, a portion of the substrate may be removable; for example, the sample cassette may have a detachable detection cassette, such that the entire sample cassette is not contacted with the detection apparatus. See for example U.S. Pat. No. 5,603,351 and PCT US96/17116, hereby incorporated by reference.

The composition of the solid substrate will depend on a variety of factors, including the techniques used to create the device, the use of the device, the composition of the sample, the analyte to be detected, the size of the wells and microchannels, the presence or absence of electronic components, etc. Generally, the devices of the invention should be easily sterilizable as well.

In a preferred embodiment, the solid substrate can be made from a wide variety of materials. Preferred embodiments utilize ceramic components as the solid substrate, as is more generally outlined below, although as will be appreciated by those in the art, the devices of the invention may include other materials. These include, but are not limited to, silicon such as silicon wafers, silcon dioxide, silicon nitride, glass and fused silica, gallium arsenide, indium phosphide, aluminum, ceramics, polyimide, quartz, plastics, resins and polymers including polymethylmethacrylate, acrylics, polyethylene, polyethylene terepthalate, polycarbonate, polystyrene and other styrene copolymers, polypropylene, polytetrafluoroethylene, superalloys, zircaloy, steel, gold, silver, copper, tungsten, molybdeumn, tantalum, KOVAR, KEVLAR, KAPTON, MYLAR, brass, sapphire, etc. High quality glasses such as high melting borosilicate or fused silicas may be preferred for their UV transmission properties when any of the sample manipulation steps require light based technologies. In addition, as outlined herein, portions of the internal surfaces of the device may be coated with a variety of coatings as needed, to reduce non-specific binding, to allow the attachment of binding ligands, for biocompatibility, for flow resistance, etc.

In a preferred embodiment, the solid support comprises ceramic materials, such as are outlined in U.S. Ser. Nos. 09/235,081; 09/337,086; 09/464,490; 09/492,013; 09/466,325; 09/460,281; 09/460,283; 09/387,691; 09/438,600; 09/506,178; and 09/458,534; all of which are expressly incorporated by reference in their entirety. In this embodiment, the devices are made from layers of green-sheet that have been laminated and sintered together to form a substantially monolithic structure. Green-sheet is a composite material that includes inorganic particles of glass, glass-ceramic, ceramic, or mixtures thereof, dispersed in a polymer binder, and may also include additives such as plasticizers and dispersants. The green-sheet is preferably in the form of sheets that are 50 to 250 microns thick. The ceramic particles are typically metal oxides, such as aluminum oxide or zirconium oxide. An example of such a green-sheet that includes glass-ceramic particles is “AX951” that is sold by E. I. Du Pont de Nemours and Company. An example of a green-sheet that includes aluminum oxide particles is “Ferro Alumina” that is sold by Ferro Corp. The composition of the green-sheet may also be custom formulated to meet particular applications. The green-sheet layers are laminated together and then fired to form a substantially monolithic multilayered structure. The manufacturing, processing, and applications of ceramic green-sheets are described generally in Richard E. Mistler, “Tape Casting: The Basic Process for Meeting the Needs of the Electronics Industry,” Ceramic Bulletin, vol. 69, no. 6, pp. 1022-26 (1990), and in U.S. Pat. No. 3,991,029, which are incorporated herein by reference.

The method for fabricating devices (such as those depicted in FIGS. 27-30 as devices 100 and 200) begins with providing sheets of green-sheet that are preferably 50 to 250 microns thick. The sheets of green-sheet are cut to the desired size, typically 6 inches by 6 inches for conventional processing, although smaller or larger devices may be used as needed. Each green-sheet layer may then be textured using various techniques to form desired structures, such as vias, channels, or cavities, in the finished multilayered structure.

Various techniques may be used to texture a green-sheet layer. For example, portions of a green-sheet layer may be punched out to form vias or channels. This operation may be accomplished using conventional multilayer ceramic punches, such as the Pacific Trinetics Corp. Model APS-8718 Automated Punch System. Instead of punching out part of the material, features, such as channels and wells may be embossed into the surface of the green-sheet by pressing the green-sheet against an embossing plate that has a negative image of the desired structure. Texturing may also be accomplished by laser tooling with a laser via system, such as the Pacific Trinetics LVS-3012.

Next, a wide variety of materials may be applied, preferably in the form of thick-film pastes, to each textured green-sheet layer. For example, electrically conductive pathways may be provided by depositing metal-containing thick-film pastes onto the green-sheet layers. Thick-film pastes typically include the desired material, which may be either a metal or a dielectric, in the form of a powder dispersed in an organic vehicle, and the pastes are designed to have the viscosity appropriate for the desired deposition technique, such as screen-printing. The organic vehicle may include resins, solvents, surfactants, and flow-control agents. The thick-film paste may also include a small amount of a flux, such as a glass frit, to facilitate sintering. Thick-film technology is further described in J. D. Provance, “Performance Review of Thick Film Materials,” Insulation/Circuits (April, 1977) and in Morton L. Topfer, Thick Film Microelectronics, Fabrication, Design, and Applications (1977), pp. 41-59, which are incorporated herein by reference.

The porosity of the resulting thick-film can be adjusted by adjusting the amount of organic vehicle present in the thick-film paste. Specifically, the porosity of the thick-film can be increased by increased the percentage of organic vehicle in the thick-film paste. Similarly, the porosity of a green-sheet layer can be increased by increasing the proportion of organic binder. Another way of increasing porosity in thick-films and green-sheet layers is to disperse within the organic vehicle, or the organic binder, another organic phase that is not soluble in the organic vehicle. Polymer microspheres can be used advantageously for this purpose.

To add electrically conductive pathways, the thick film pastes typically include metal particles, such as silver, platinum, palladium, gold, copper, tungsten, nickel, tin, or alloys thereof. Silver pastes are preferred. Examples of suitable silver pastes are silver conductor composition numbers 7025 and 7713 sold by E. I. Du Pont de Nemours and Company.

The thick-film pastes are preferably applied to a green-sheet layer by screen-printing. In the screen-printing process, the thick-film paste is forced through a patterned silk screen so as to be deposited onto the green-sheet layer in a corresponding pattern. Typically, the silk screen pattern is created photographically by exposure to a mask. In this way, conductive traces may be applied to a surface of a green-sheet layer. Vias present in the green-sheet layer may also be filled with thick-film pastes. If filled with thick-filled pastes containing electrically conductive materials, the vias can serve to provide electrical connections between layers.

After the desired structures are formed in each layer of green-sheet, preferably a layer of adhesive is applied to either surface of the green-sheet. Preferably, the adhesive is a room-temperature adhesive. Such room-temperature adhesives have glass transition temperatures below room temperature, i.e., below about 20° C., so that they can bind substrates together at room temperature. Moreover, rather than undergoing a chemical change or chemically reacting with or dissolving components of the substrates, such room-temperature adhesives bind substrates together by penetrating into the surfaces of the substrates. Sometimes such room-temperature adhesives are referred to as “pressure-sensitive adhesives.” Suitable room-temperature adhesives are typically supplied as water-based emulsions and are available from Rohm and Haas, Inc. and from Air Products, Inc. For example, a material sold by Air Products, Inc. as “Flexcryl 1653” has been found to work well.

The room-temperature adhesive may be applied to the green-sheet by conventional coating techniques. To facilitate coating, it is often desirable to dilute the supplied pressure-sensitive adhesive in water, depending on the coating technique used and on the viscosity and solids loading of the starting material. After coating, the room-temperature adhesive is allowed to dry. The dried thickness of the film of room-temperature adhesive is preferably in the range of 1 to 10 microns, and the thickness should be uniform over the entire surface of the green-sheet. Film thicknesses that exceed 15 microns are undesirable. With such thick films of adhesive voiding or delamination can occur during firing, due to the large quantity of organic material that must be removed. Films that are less than about 0.5 microns thick when dried are too thin because they provide insufficient adhesion between the layers.

From among conventional coating techniques, spin-coating and spraying are the preferred methods. If spin-coating is used, it is preferable to add 1 gram of deionized water for every 10 grams of “Flexcryl 1653.” If spraying is used, a higher dilution level is preferred to facilitate ease of spraying. Additionally, when room-temperature adhesive is sprayed on, it is preferable to hold the green-sheet at an elevated temperature, e.g., about 60 to 70° C., so that the material dries nearly instantaneously as it is deposited onto the green-sheet. The instantaneous drying results in a more uniform and homogeneous film of adhesive.

After the room-temperature adhesive has been applied to the green-sheet layers, the layers are stacked together to form a multilayered green-sheet structure. Preferably, the layers are stacked in an alignment die, so as to maintain the desired registration between the structures of each layer. When an alignment die is used, alignment holes must be added to each green-sheet layer. Typically, the stacking process alone is sufficient to bind the green-sheet layers together when a room-temperature adhesive is used. In other words, little or no pressure is required to bind the layers together. However, in order to effect a more secure binding of the layers, the layers are preferably laminated together after they are stacked.

The lamination process involves the application of pressure to the stacked layers. For example, in the conventional lamination process, a uniaxial pressure of about 1000 to 1500 psi is applied to the stacked green-sheet layers that is then followed by an application of an isostatic pressure of about 3000 to 5000 psi for about 10 to 15 minutes at an elevated temperature, such as 70° C. Adhesives do not need to be applied to bind the green-sheet layers together when the conventional lamination process is used.

However, pressures less than 2500 psi are preferable in order to achieve good control over the dimensions of such structures as internal or external cavities and channels. Even lower pressures are more desirable to allow the formation of larger structures, such as cavities and channels. For example, if a lamination pressure of 2500 psi is used, the size of well-formed internal cavities and channels is typically limited to no larger than roughly 20 microns. Accordingly, pressures less than 1000 psi are more preferred, as such pressures generally enable structures having sizes greater than about 100 microns to be formed with some measure of dimensional control. Pressures of less than 300 psi are even more preferred, as such pressures typically allow structures with sizes greater than 250 microns to be formed with some degree of dimensional control. Pressures less than 100 psi, which are referred to herein as “near-zero pressures,” are most preferred, because at such pressures few limits exist on the size of internal and external cavities and channels that can be formed in the multilayered structure.

The pressure is preferably applied in the lamination process by means of a uniaxial press.

Alternatively, pressures less than about 100 psi may be applied by hand.

As with semiconductor device fabrication, many devices may be present on each sheet.

Accordingly, after lamination the multilayered structure may be diced using conventional green-sheet dicing or sawing apparatus to separate the individual devices. The high level of peel and shear resistance provided by the room-temperature adhesive results in the occurrence of very little edge delamination during the dicing process. If some layers become separated around the edges after dicing, the layers may be easily re-laminated by applying pressure to the affected edges by hand, without adversely affecting the rest of the device.

The final processing step is firing to convert the laminated multilayered green-sheet structure from its “green” state to form the finished, substantially monolithic, multilayered structure. The firing process occurs in two important stages as the temperature is raised. The first important stage is the binder burnout stage that occurs in the temperature range of about 250 to 500° C., during which the other organic materials, such as the binder in the green-sheet layers and the organic components in any applied thick-film pastes, are removed from the structure.

In the next important stage, the sintering stage, which occurs at a higher temperature, the inorganic particles sinter together so that the multilayered structure is densified and becomes substantially monolithic. The sintering temperature used depends on the nature of the inorganic particles present in the green-sheet. For many types of ceramics, appropriate sintering temperatures range from about 950 to about 1600° C., depending on the material. For example, for green-sheet containing aluminum oxide, sintering temperatures between 1400 and 1600° C. are typical. Other ceramic materials, such as silicon nitride, aluminum nitride, and silicon carbide, require higher sintering temperatures, namely 1700 to 2200° C. For green-sheet with glass-ceramic particles, a sintering temperature in the range of 750 to 950° C. is typical. Glass particles generally require sintering temperatures in the range of only about 350 to 700° C. Finally, metal particles may require sintering temperatures anywhere from 550 to 1700° C., depending on the metal.

Typically, the devices are fired for a period of about 4 hours to about 12 hours or more, depending on the material used. Generally, the firing should be of a sufficient duration so as to remove the organic materials from the structure and to completely sinter the inorganic particles. In particular, polymers are present as a binder in the green-sheet and in the room-temperature adhesive. The firing should be of sufficient temperature and duration to decompose these polymers and to allow for their removal from the multilayered structure.

Typically, the multilayered structure undergoes a reduction in volume during the firing process. During the binder burnout phase, a small volume reduction of about 0.5 to 1.5% is normally observed. At higher temperatures, during the sintering stage, a further volume reduction of about 14 to 17% is typically observed.

The volume change due to firing, on the other hand, can be controlled. In particular, to match volume changes in two materials, such as green-sheet and thick-film paste, one should match: (1) the particle sizes; and (2) the percentage of organic components, such as binders, which are removed during the firing process. Additionally, volume changes need not be matched exactly, but any mismatch will typically result in internal stresses in the device. But symmetrical processing, placing the identical material or structure on opposite sides of the device can, to some extent, compensate for shrinkage mismatched materials. Too great a mismatch in either sintering temperatures or volume changes may result in defects in or failure of some or all of the device. For example, the device may separate into its individual layers, or it may become warped or distorted.

As noted above, preferably any dissimilar materials added to the green-sheet layers are co-fired with them. Such dissimilar materials could be added as thick-film pastes or as other green-sheet layers, or added later in the fabrication process, after sintering. The benefit of co-firing is that the added materials are sintered to the green-sheet layers and become integral to the substantially monolithic microfluidic device. However, to be co-fireable, the added materials should have sintering temperatures and volume changes due to firing that are matched with those of the green-sheet layers. Sintering temperatures are largely material-dependent, so that matching sintering temperatures simply requires proper selection of materials. For example, although silver is the preferred metal for providing electrically conductive pathways, if the green-sheet layers contain alumina particles, which require a sintering temperature in the range of 1400 to 1600° C., some other metal, such as platinum, must be used due to the relatively low melting point of silver (961° C.).

Alternatively, the addition of other substrates or joining of two post-sintered pieces can be done using any variety of adhesive techniques, including those outlined herein. For example, two “halves” of a device can be glued or fused together. For example, a particular detection platform, reagent mixture such as a hydrogel or biological components that are not stable at high temperature can be sandwiched in between the two halves. Alternatively, ceramic devices comprising open channels or wells can be made, additional substrates or materials placed into the devices, and then they may be sealed with other materials.

The substrates comprise arrays of capture binding ligands. As will be appreciated by those in the art, any number of different capture binding ligands, or capture probes (when the target analyte is a nucleic acid) can be used, and in a wide variety of formats. Preferred embodiments utilize arrays of microelectrodes or hydrogel arrays as are known in the art and disclosed, for example, in U.S. Ser. Nos. 09/458,553; 09/458,501; 09/572,187; 09/495,992; 09/344,217; WO00/31148; 09/439,889; 09/438,209; 09/344,620; PCTUS00/17422; 09/478,727, all of which are expressly incorporated by reference in their entirety.

In some embodiments of the present invention, the probes are oligonucleotide probes having a sequence comprising from about 10 to about 30 nucleotide residues wherein said probes are attached to a conjugated polymer or copolymer that is in contact with the microelectrodes. The conjugated polymer or copolymer used for probe attachment includes, but is not limited to, polypyrrole, polythiphene, polyaniline, polyfuran, polypyridine, polycarbazole, polyphenylene, poly (phenylenvinylene), polyfluorene, polyindole, their derivatives, their copolymers, and combinations thereof. In a preferred embodiment, the oligonucleotide probes are attached to the microelectrodes through a neutral polypyrrole matrix.

In other embodiments of the present invention, the probes are oligonucleotide probes having a sequence comprising from about 10 to about 30 nucleotide residues and said probes are attached to polyacrylamide gel pads that are in contact with the microelectrodes.

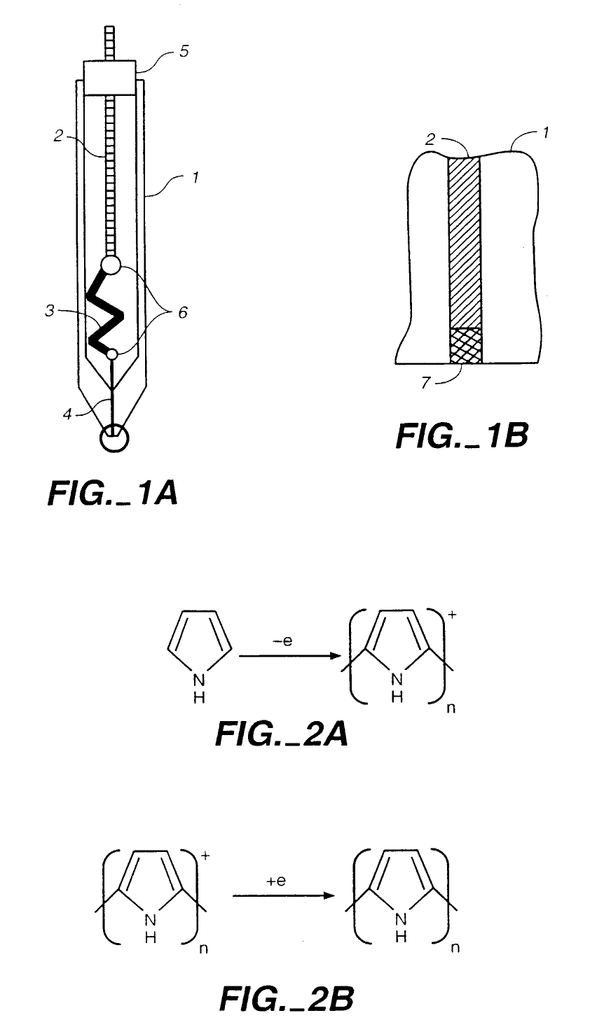

As is known in the art, samples are prepared in a variety of ways and applied to a device of the invention. Preferred embodiments are directed to the use of systems that do not require the use of ECA labels and are discussed below with reference to FIGS. 1-14 and Examples 1-6.

In this embodiment, the apparatus and methods of the present invention are illustrated herein using hybridization between oligonucleotide probes immobilized on microelectrodes and target nucleic acid molecules contained in a biological sample. The phosphate groups of nucleic acids are negatively charged at all biologically relevant pH values. Thus, a nucleic acid duplex possesses a high negative charge density. Following electrical perturbation of the nucleic acid, strong interactions, such as the intercalation or binding of metal ions to the nucleic acid, occur. These interactions are dependent upon the structure and charge density of the nucleic acid. Since the structural and electrical properties of a nucleic acid molecule (such as a probe) are altered when the probe is hybridized to a suitable target molecule, the result of this molecular interaction is a change in AC impedance. This change is used in the methods and apparatus of the invention to distinguish between “complete” hybridization and incomplete or “mismatch” hybridization between the immobilized oligonucleotide probe and target nucleic acid.

In one embodiment, the apparatus of the present invention comprises a supporting substrate, a plurality of microelectrodes in contact with the supporting substrate to which probes are immobilized, at least one counter-electrode in contact with the supporting substrate, a means for producing electrical impedance at each microelectrode, a means for detecting changes in impedance at each microelectrode in the presence or absence of a target molecule, and an electrolyte solution in contact with the plurality of microelectrodes.

In another embodiment, the apparatus of the present invention comprises a supporting substrate, a plurality of microelectrodes in contact with the supporting substrate, a plurality of polyacrylamide gel pads in contact with the microelectrodes and to which probes are immobilized, at least one counter-electrode in contact with the supporting substrate, a means for producing electrical impedance at each microelectrode, a means for detecting changes in impedance at each microelectrode in the presence or absence of a target molecule, and an electrolyte solution in contact with the plurality of microelectrodes.

In one embodiment, the apparatus is a microarray containing at least 5 microelectrodes on a single substrate to which oligonucleotide probes have been attached. Alternatively, arrayed oligonucleotides are attached to polyacrylamide gel pads that are in contact with the microelectrodes of the apparatus of the present invention. Most preferably, oligonucleotides having a particular nucleotide sequence, or groups of such oligonucleotides having related (e.g., overlapping) nucleotide sequences, are immobilized at each of the plurality of microelectrodes. In further preferred embodiments, the nucleotide sequence(s) of the immobilized oligonucleotides at each microelectrode, and the identity and correspondence between a particular microelectrode and the nucleotide sequence of the oligonucleotide immobilized thereto, are known.

In preferred embodiments, the probes are oligonucleotides comprising from about 10 to about 100, more preferably from about 10 to about 50, and most preferably from about 15 to about 30, nucleotide residues. In alternative embodiments, the probes are nucleic acids comprising from about 10 to about 5000 basepairs, more preferably from about 100 to about 1000 basepairs, and most preferably from about 200 to about 500 basepairs. In further preferred embodiments, the immobilized probes are peptides comprising from about 5 to about 500 amino acid residues.

In the preferred embodiment of the apparatus of the present invention, the substrate is composed of silicon. In alternative embodiments, the substrate is prepared from substances including, but not limited to, glass, plastic, rubber, fabric, or ceramics. The microelectrodes are embedded within or placed in contact with the substrate.

In preferred embodiments, microelectrodes are prepared from substances including, but not limited to, metals such as gold, silver, platinum, titanium or copper, in solid or porous form and preferably as foils or films, metal oxides, metal nitrides, metal carbides, or carbon. In certain preferred embodiments, probes are attached to conjugated polymers or copolymers including, but not limited to, polypyrrole, polythiphene, polyaniline, polyfuran, polypyridine, polycarbazole, polyphenylene, poly(phenylenvinylene), polyfluorene, polyindole, their derivatives, their copolymers, and combinations thereof. In alternative embodiments, probes are attached to polyacrylamide gel pads that are in contact with the microelectrodes.

The substrate of the present invention has a surface area of between 0.01 mm² and 5 cm² containing between 1 and 1×10⁸ microelectrodes. In one embodiment, the substrate has a surface area of 100 mm² and contains 10⁴ microelectrodes, each microelectrode having an oligonucleotide having a particular sequence immobilized thereto. In another embodiment, the substrate has a surface area of 100 mm² and contains 10⁴ microelectrodes, each microelectrode in contact with a polyacrylamide gel pad to which an oligonucleotide having a particular sequence has been immobilized thereto. In preferred embodiments, the microelectrodes are arranged on the substrate so as to be separated by a distance of between 0.05 mm to 0.5 mm. Most preferably, the microelectrodes are regularly spaced on the solid substrate with a uniform spacing there between.

In some embodiments of the present invention, the microelectrodes project from the surface of the substrate, with such projections extending between 5×10⁻⁸ and 1×10⁻⁵ cm from the surface of the substrate. In other embodiments, the microelectrodes comprise a flat disk of conductive material that is embedded in the substrate and exposed at the substrate surface, with the substrate acting as an insulator in the spaces between the microelectrodes.

In the preferred embodiment of the present invention the microelectrodes comprise a gold conductor and glass insulator. In alternative embodiments, the microelectrodes comprise conductor substances such as solid or porous films of silver, platinum, titanium, copper, or metal oxides, metal nitrides, metal carbides, or carbon (graphite). In alternative embodiments, the microelectrodes comprise substrate and/or insulator substances such as glass, silicon, plastic, rubber, fabric, or ceramics. The microelectrodes of the present invention have an exposed conductive surface of between 0.01 mm² to 0.5 cm². In the preferred embodiment, the exposed conductive material is between 100 to 10,000 mm². One embodiment of the present invention is shown in FIG. 1A, wherein the microelectrode comprises a glass capillary tube 1, containing an ultra fine platinum wire 2, to which a transition wire 3 has been soldered 6. The transition wire 3, is soldered 6 in turn to a hookup wire 4, which protrudes from an epoxy plug 5 that seals the capillary tube. In one embodiment of the present invention, polyacrylamide gel material 7 is packed into a recess etched into the exposed surface of the platinum wire 2.

In some embodiments, oligonucleotide probes are immobilized on the microelectrodes of the apparatus of the present invention using a neutral layer between the oligonucleotides and the microelectrodes. In a preferred embodiment, this layer comprises neutral polypyrrole. In alternative embodiments, this layer comprises such substances as polythiphene, polyaniline, polyfuran, polypyridine, polycarbazole, polyphenylene, poly(phenylenvinylene), polyfluorene, polyindole, their derivatives, their copolymers, and combinations thereof. The layer is preferably at least about 0.001 to 50 mm thick, more preferably at least about 0.01 to 10 mm thick and most preferably at least about 0.5 mm thick.

In other embodiments, oligonucleotide probes are immobilized on polyacrylamide gel pads in contact with the microelectrodes of the apparatus of the present invention. In a preferred embodiment, the polyacrylamide gel pad is embedded into a recess etched into the surface of the microelectrode. The polyacrylamide gel pad is preferably at least about 0.1 to 30 mm thick, more preferably at least about 0.5 to 10 mm thick, and most preferably about 0.5 mm thick

The apparatus of the present invention comprises at least one counter-electrode. In the preferred embodiment of the present invention the counter-electrode comprises a conductive material, with an exposed surface that is significantly larger than that of the individual microelectrodes. In a preferred embodiment, the counter electrode comprises platinum. In alternative embodiments, the counter electrode comprises solid or porous films of silver, gold, platinum, titanium, copper, or metal oxides, metal nitrides, metal carbides, or carbon.

In other embodiments of the present invention, the apparatus comprises at least one reference electrode. The reference electrode is used in assays where the further quantification of target molecules is desired. In preferred embodiments, the reference electrode comprises a silver/silver chloride electrode. In alternative embodiments, the reference electrode comprises solid or porous films of gold, platinum, titanium, or copper, metal oxides, metal nitrides, metal carbides, or carbon. The electrolyte solution comprising the apparatus of the present invention is any electrolyte solution comprising at least one salt containing metal or polymerized cations that are ion-conductive and can react with biological molecules, most preferably nucleic acids or peptides. Most preferably, the salt further comprises anions that exhibit a reduced specific adsorption for the surface of the microelectrode, thereby reducing the noise during the detection of molecular interactions between probe and target molecules.

In a preferred embodiment of the present invention, the electrolyte solution used for the detection of nucleic acid hybridization contains 0.1 M LiClO₄. This electrolyte is preferred since ClO₄ is not specifically adsorbed on the electrode surface and thus generates a low background noise. In addition, Li⁺ is preferred since its small size facilitates intercalation of the Li⁺ cations into the nucleic acid duplex and has less diffusion resistance. However, in other embodiments, the AC impedance is measured in hybridization buffers such as 1×SSC following molecular interactions between probe and target molecules.

In the apparatus of the present invention the means for producing electrical impedance at each microelectrode can be accomplished using a model 1260 Impedance/Gain-Phase Analyser with model 1287 Electrochemical Interface (Solartron Inc., Houston, Tex.). Other electrical impedance measurement means include, but are not limited to, transient methods with AC signal perturbation superimposed upon a DC potential applied to an electrochemical cell such as AC bridge and AC voltammetry. The measurements can be conducted at certain frequency determined by scanning frequencies to ascertain the frequency producing the highest signal. The means for detecting changes in impedance at each microelectrode in the presence or absence of a target molecule can be accomplished by using one of the above-described instruments.

In still further alternative embodiments of the present invention, the apparatus further comprises a plurality of wells each of which encompasses at least one microelectrode and at least one counter-electrode. The term “wells” is used herein in its conventional sense, to describe a portion of the substrate in which the microelectrode and at least one counter-electrode are contained in a defined volume.

The present invention provides an apparatus and methods for detecting molecular interactions by detecting cation interactions associated with nucleic acid hybridization. The detection method used is most preferably AC impedance, but encompasses any detection methods that do not employ or require a reporter-labeled moiety to obtain measurable signals. The impedance is measured at different frequencies in order to obtain a “signature” of the hybridization reaction that is sensitive enough to permit mismatch hybridization between the oligonucleotide probe and target molecules to be detected. The inventive methods disclosed herein are useful for electrical detection of molecular interactions between probe molecules bound to defined regions of an ordered array (conventionally termed “a biochip array”) and target molecules in a sample which are permitted to interact with the probe molecules. By arraying microelectrodes to which individual probe molecules have been attached on a biochip, parallel measurements of many probes can be performed in a single assay.

The present invention further provides an apparatus and methods for detecting cation interactions associated with peptide binding using AC impedance, but without the use of reporter-labeled target to obtain measurable signals. The methods are used for electrical detection of molecular interactions between probe molecules bound to defined regions of an ordered peptide array and target molecules in a sample which are permitted to interact with the probe molecules. By arraying microelectrodes to which individual probe molecules have been attached on a biochip, parallel measurements of many probes can be performed in a single assay.

The apparatus and methods of the present invention can be adapted further to be used with arrays of any substance that can participate in a molecular interaction that can be interrogated with cations, most preferably lithium cations. Such interactions include ligand-receptor interactions, enzyme-inhibitor interactions, and antigen-antibody interactions.

An important advantage of the apparatus and methods of the present invention is that they are not dependent on labeling the target molecule. By removing the labeling step, the cost of the assay is reduced as well as simplified, thereby making electrical detection easier and more cost-effective to use. Furthermore, by not requiring target molecules to be labeled, the range of assays for which a method of the present invention may be employed is extended. For example, the present invention enables one to perform high sensitivity, high resolution measurements of RNA concentrations in gene expression studies without having to label the chemically-labile RNA or to convert the RNA into cDNA. The methods of the present invention may also enable new types of assays to be developed.

In an additional embodiment, the invention relies on the use of ECA labels and detection on hydrogel arrays. The apparatus and methods of the present invention are illustrated herein using hybridization between oligonucleotide probes immobilized to a polymeric hydrogel pad that is placed in contact with a microelectrode (a hydrogel porous microelectrode) and electrochemically-labeled target nucleic acid molecules contained in a biological sample.

In a preferred embodiment, the apparatus of the present invention comprises a supporting substrate, a plurality of microelectrodes in contact with the supporting substrate, a plurality of polyacrylamide gel pads in contact with the microelectrodes and to which probes are immobilized, at least one counter-electrode in contact with the supporting substrate, a means for producing an electrical signal at each microelectrode, a means for detecting changes in the electrical signal at each microelectrode in the presence or absence of an electrochemically active reporter-labeled target molecule, and an electrolyte solution in contact with the plurality of microelectrodes and polymeric hydrogel pads and the counter-electrode. The polymeric hydrogel is constructed from hydrophilic polymeric materials including but not limited to polyacrylamide, agarose gel, polyethylene glycol, cellular, and sol gels.

In one embodiment, the apparatus is a microarray containing at least 10³ hydrogel porous microelectrodes to which oligonucleotide probes have been attached. Most preferably, oligonucleotides having a particular nucleotide sequence, or groups of such oligonucleotides having related (e.g., overlapping) nucleotide sequences, are immobilized at each of the plurality of hydrogel porous microelectrodes. In further preferred embodiments, the nucleotide sequence(s) of the immobilized oligonucleotides at each hydrogel porous microelectrode, and the identity and correspondence between a particular hydrogel porous microelectrode and the nucleotide sequence of the oligonucleotide immobilized thereto, are known.

In preferred embodiments, the probes are oligonucleotides comprising from about 10 to about 100, more preferably from about 10 to about 50, and most preferably from about 15 to about 30, nucleotide residues. In alternative embodiments, the probes are nucleic acids comprising from about 10 to about 5000 basepairs, more preferably from about 100 to about 1000 basepairs, and most preferably from about 200 to about 500 basepairs. In further preferred embodiments, the immobilized probes are peptides comprising from about 5 to about 500 amino acid residues.

In the preferred embodiment of the apparatus of the present invention, the substrate is composed of silicon. In alternative embodiments, the substrate is prepared from substances including, but not limited to, glass, plastic, rubber, fabric, or ceramics. The hydrogel porous microelectrodes are embedded within or placed in contact with the substrate.

In preferred embodiments, microelectrodes are prepared from substances including, but not limited to, metals such as gold, silver, platinum, titanium or copper, in solid or porous form and preferably as foils or films, metal oxides, metal nitrides, metal carbides, or carbon. In the apparatus of the present invention, the probes are attached to polyacryiamide gel pads that are placed in contact with the microelectrodes.

The substrate of the present invention has a surface area of between 0.01 mm² and 5 cm² containing between 1 and 1×10⁸ hydrogel porous microelectrodes. In one embodiment, the substrate has a surface area of 10,000 mm² and contains 10⁴ hydrogel porous microelectrodes, each of which has an oligonucleotide having a particular sequence immobilized thereto. In preferred embodiments, the hydrogel porous microelectrodes are arranged on the substrate so as to be separated by a distance of between 0.05 mm to 0.5 mm. Most preferably, the hydrogel porous microelectrodes are regularly spaced on the solid substrate with a uniform spacing there between.

In some embodiments of the present invention, the hydrogel porous microelectrodes project from the surface of the substrate, with such projections extending between 5×10⁻⁸ and 1×10⁻⁵ cm from the surface of the substrate. In other embodiments, the hydrogel porous microelectrodes comprise a flat disk of conductive material that is embedded in the substrate and exposed at the substrate surface, with the substrate acting as an insulator in the spaces between the hydrogel porous microelectrodes.

In a preferred embodiment of the present invention the microelectrodes comprise a gold conductor and glass insulator. In alternative embodiments, the microelectrodes comprise conductor substances such as solid or porous films of silver, platinum, titanium, or copper, metal oxides, metal nitrides, metal carbides, or carbon. In alternative embodiments, the microelectrodes comprise substrate and/or insulator substances such as glass, silicon, plastic, rubber, fabric, or ceramics. The microelectrodes of the present invention have an exposed conductive surface of between 0.01 mm² to 0.5 cm². In the preferred embodiment, the exposed conductive material is between 100 to 160,000 mm².

One embodiment of the present invention is shown in FIG. 1A, wherein the microelectrode comprises a glass capillary tube 1, containing an ultra fine platinum wire 2, to which a transition wire 3 has been soldered 6. The transition wire 3, is soldered 6 in turn to a hookup wire 4, which protrudes from an epoxy plug 5 that seals the capillary tube. In one embodiment of the present invention, polyetrylamide gel material 7 is packed into a recess etched into the exposed surface of the platinum wire 2. In a preferred embodiment, the polyacrylamide gel pad is embedded into a recess etched into the surface of the microelectrode. The polymerix hydrogel pad is preferably at least about 0.1 to 30 mm thick, more preferably at least about 0.5 to 10 mm thick, and most preferably about 0.5 mm thick. In one embodiment of the hydrogel porous microelectrode of the present invention, oligonucleotide probes are immobilized on the polyacrylamide gel.

The apparatus of the present invention comprises at least one counter-electrode. In the preferred embodiment of the present invention the counter-electrode comprises a conductive material, with an exposed surface that is significantly larger than that of the individual microelectrodes. In a preferred embodiment, the counter electrode comprises platinum. In alternative embodiments, the counter electrode comprises solid or porous films of silver, gold, platinum, titanium, or copper, metal oxides, metal nitrides, metal carbides, or carbon.

In other embodiments of the present invention, the apparatus comprises at least one reference electrode. The reference electrode is used in assays where the further quantification of target molecules is desired. In preferred embodiments, the reference electrode comprises a silver/silver chloride electrode. In alternative embodiments, the reference electrode comprises solid or porous films of gold, platinum, titanium, or copper, metal oxides, metal nitrides, metal carbides, or carbon.

In still further alternative embodiments of the present invention, the apparatus further comprises a plurality of wells each of which encompasses at least one hydrogel porous microelectrode and at least one counter-electrode. The term “wells” is used herein in its conventional sense, to describe a portion of the substrate in which the hydrogel porous microelectrode and at least one counter-electrode are contained in a defined volume.

In the method of the present invention, molecular interactions between probe molecules bound to hydrogel porous microelectrodes and electrochemically-labeled target molecules are detected. Electrochemically-labeled target molecules useful in the methods of the present invention may be prepared by labeling suitable target molecules with any electrochemically-distinctive redox reporter which does not interfere with the molecular interaction to be detected. In preferred embodiments of the method of the present invention, target molecules are labeled with electrochemical reporter groups comprising a transition metal complex, most preferably containing a transition metal ion that is ruthenium, cobalt, iron, or osmium.

In other embodiments of the present invention, target molecules may be labeled with the following non-limiting examples of electrochemically-active moieties:

Redox moieties useful against an aqueous saturated calomel reference electrode include, but are not limited to, transition metal complexes, 1,4-benzoquinone, ferrocene, tetracyanoquinodimethane, N,N,N′,N′-tetramethyl-p-phenylenediamine, or tetrathiafulvalene.

Redox moieities useful against an Ag/AgCl reference electrode include: 9-aminoacridine, acridine orange, aclarubicin, daunomycin, doxorubicin, pirarubicin, ethidium bromide, ethidium monoazide, chlortetracycline, tetracycline, minocycline, Hoechst 33258, Hoechst 33342, 7-aminoactinomycin D, Chromomycin A₃, mithramycin A, Vinblastine, Rifampicin, Os(bipyridine)₂(dipyridophenazine)₂⁺, Co(bipyridine)₃³⁺, or Fe-bleomycin.

The electrochemically-active moiety comprising the electrochemically active reporter-labeled target molecule of the method of the present invention is optionally linked to the target molecule through a linker, preferably having a length of from about 10 to about 20 Angstroms. The linker can be an organic moiety such as a hydrocrabon chain (CH₂)ₙ, or can comprise an ether, ester, carboxyamide, or thioether moiety, or a combination thereof. The linker can also be an inorganic moiety such as siloxane (O—Si—O). The length of the linker is selected so that the electrochemically-active moiety does not interfere with the molecular interaction to be detected.

Electrochemical contact is advantageously provided using an electrolyte solution in contact with each of the hydrogel porous microelectrodes of the invention. Electrolyte solutions useful in the apparatus and methods of the invention include any electrolyte solution at physiologically-relevant ionic strength (equivalent to about 0.15 M NaCl) and neutral pH. Examples of electrolyte solutions useful with the apparatus and methods of the invention include but are not limited to phosphate buffered saline, HEPES buffered solutions, and sodium bicarbonate buffered solutions.

In preferred embodiments, the present invention provides an apparatus and methods for detecting molecular interactions by detecting changes in AC impedance. The impedance is measured at different frequencies in order to obtain a “signature” of the hybridization reaction that is sensitive enough to permit mismatch hybridization between the oligonucleotide probe and target molecules to be detected. The inventive methods disclosed herein are useful for electrochemical detection of molecular interactions between probe molecules bound to defined regions of an ordered array (conventionally termed “a biochip array”) and electrochemically-labeled target molecules in a sample which are permitted to interact with the probe molecules. By arraying microelectrodes to which individual probe molecules have been attached on a biochip, parallel measurements of many probes can be performed in a single assay.

In one embodiment of the apparatus of the present invention, the means for producing electrical impedance at each microelectrode is accomplished using a model 1260 Impedance/Gain-Phase Analyser with model 1287 Electrochemical Interface (Solartron Inc., Houston, Tex.). Other electrical impedance measurement means include, but are not limited to, transient methods with AC signal perturbation superimposed upon a DC potential applied to an electrochemical cell such as AC bridge and AC voltammetry. The measurements can be conducted at certain frequency determined by scanning frequencies to ascertain the frequency producing the highest signal. The means for detecting changes in impedance at each microelectrode in the presence or absence of a electrochemically-labeled target molecule can be accomplished by using one of the above-described instruments.

In other embodiments of the present invention, other electric and/or electrochemical methods can be used to detect molecular interactions between probe molecules and electrochemically-labeled target molecules, including, but not limited to, cyclic voltammetry, stripping voltammetry, pulse voltammetry, square wave voltammetry, AC voltammetry, hydrodynamic modulation voltammetry, potential step method, potentiometric measurements, amperometric measurements, current step method, and combinations thereof. In these embodiments, the electrical signal is current flow in response to an applied voltage at the redox potential of the electrochemical label.

The present invention also provides an apparatus and methods for detecting single nucleotide polymorphisms (SNP) in a nucleic acid sample comprising a specific target nucleic acid.

The devices of the invention are particularly useful for analyzing target nucleic acid for the diagnosis of infectious and genetic disease. The target nucleic acid is generally a portion of a gene having a known nucleotide sequence that is associated with an infectious agent or genetic disease; more specifically, the disease is caused by a single nucleotide (or point) mutation. The device incorporates a nucleic acid oligonucleotide array specific for the target gene, and means for detecting and determining the identity of a specific single base in the target sequence adjacent to the hybridization site of at least one probe in the oligonucleotide array (termed the “3′ offset method”) or encompassing the 3′ residue of at least one oligonucleotide probe in the array (termed the “3′ inclusive method”).

The present invention provides an array of oligonucleotide primers or probes immobilized to a surface that defines a first electrode. Preferably, the sequence of each oligonucleotide at each address in the array is known and at least one oligonucleotide in said oligonucleotide array is complementary to part of a sequence in a nucleic acid in the sample to be assayed. The sequence of at least one oligonucleotide is most preferably selected to extend to a position immediately adjacent to the nucleotide position in the sample nucleic acid that is to be interrogated, i.e., for mutation or genetic polymorphism. Alternatively, the oligonucleotide is selected to encompass the site of mutation or genetic polymorphism; in these latter embodiments, it is generally preferred to provide a multiplicity of oligonucleotides having one of each possible nucleotide at the polymorphic position to ensure hybridization of at least one of the oligonucleotides in the array to nucleic acid in the sample. Hybridization and extension reactions are performed in a reaction chamber and in a hybridization buffer for a time and at temperature that permits hybridization to occur between nucleic acid in the sample and the oligonucleotides in the array complementary thereto.

In one embodiment, the apparatus of the present invention comprises a supporting substrate, a plurality of a first electrode (or an array of microelectrodes) in contact with the supporting substrate to which probes are immobilized, at least one counter-electrode and optionally a reference electrode, and an electrolyte solution in contact with the plurality of microelectrodes, counter electrode and reference electrode.

In another embodiment, the apparatus of the present invention comprises a supporting substrate, a plurality of first electrodes (or an array of microelectrodes) in contact with the supporting substrate, a plurality of polyacrylamide gel pads in contact with the microelectrodes and to which probes are immobilized, at least one counter-electrode and optionally a reference electrode, and an electrolyte solution in contact with the plurality of microelectrodes, counter electrode and reference electrode. In the preferred embodiment of the apparatus of the present invention, the substrate is composed of silicon. In alternative embodiments, the substrate is prepared from substances including, but not limited to, glass, plastic, rubber, fabric, or ceramics.

The electrode comprising the first surface to which the oligonucleotide or array thereof is attached is made of at least one of the following materials: metals such as gold, silver, platinum, copper, and electrically-conductive alloys thereof; conductive metal oxides such as indium oxide, indium-tin oxide, zinc oxide; and other conductive materials such carbon black, conductive epoxy.

In preferred embodiments, microelectrodes are prepared from substances including, but not limited to, metals such as gold, silver, platinum, titanium or copper, in solid or porous form and preferably as foils or films, metal oxides, metal nitrides, metal carbides, or carbon. In certain preferred embodiments, probes are attached to conjugated polymers or copolymers including, but not limited to, polypyrrole, polythiophene, polyaniline, polyfuran, polypyridine, polycarbazole, polyphenylene, poly(phenylenvinylene), polyfluorene, polyindole, their derivatives, their copolymers, and combinations thereof. In alternative embodiments, probes are attached to polyacrylamide gel pads that are in contact with the microelectrodes.

The substrate of the present invention has a surface area of between 0.01 mm² and 5 cm² containing between 1 and 1×10⁸ microelectrodes. In one embodiment, the substrate has a surface area of 100 mm² and contains 10⁴ microelectrodes, each microelectrode having an oligonucleotide having a particular sequence immobilized thereto. In another embodiment, the substrate has a surface area of 100 mm² and contains 10⁴ microelectrodes, each microelectrode in contact with a polyacrylamide gel pad to which an oligonucleotide having a particular sequence has been immobilized thereto. In preferred embodiments, the microelectrodes are arranged on the substrate so as to be separated by a distance of between 0.05 mm² to 0.5 mm. Most preferably, the microelectrodes are regularly spaced on the solid substrate with a uniform spacing there between.

In one embodiment, the apparatus comprises a microarray containing at least 10³ microelectrodes on a single substrate to which oligonucleotide probes have been attached. Alternatively, arrayed oligonucleotides are attached to polyacrylamide gel pads that are in contact with the microelectrodes of the apparatus of the present invention. Most preferably, oligonucleotides having a particular nucleotide sequence, or groups of such oligonucleotides having related (e.g., overlapping) nucleotide sequences, are immobilized at each of the plurality of microelectrodes. In further preferred embodiments, the nucleotide sequence(s) of the immobilized oligonucleotides at each microelectrode, and the identity and correspondence between a particular microelectrode and the nucleotide sequence of the oligonucleotide immobilized thereto, are known.

The primer or probe used in the present invention is preferred to be an oligonucleotide having a length, both the upper and lower limits of which are empirically determined. The lower limit on probe length is stable hybridization: it is known in the art that probes that are too short do not form thermodynamically-stable duplexes sufficient for single base extension under the hybridization conditions of the assay. The upper limit on probe length are probes that produce a duplex in a region other than that of the predetermined interrogation target, leading to artifactual incorporation of primer extension unit(s) labeled with electrochemically active moieties. Preferred oligonucleotide primer or probes used in the present invention have a length of from about 8 to about 50, more preferably from about 10 to about 40, even more preferably from about 12 to about 30, and most preferably from about 15-25 nucleotides. However, longer probes, i.e. longer than 40 nucleotides, may also be used.

In the present invention, the primer or probe is preferably immobilized directly on the first electrode surface through an anchoring group. As will be appreciated by those in the art, advantageous anchoring groups include, for example, moieties comprising thiols, carboxylates, hydroxyls, amines, hydrazines, esters, amides, halides, vinyl groups, vinyl carboxylates, phosphates, silicon-containing organic compounds, and their derivatives. For example, an oligonucleotide which is complementary to a target DNA is covalently linked to a metallic gold electrode through a thiol-containing anchoring group. In a preferred embodiment, the length of these anchoring groups is chosen such that the conductivity of these molecules do not hinder electron transfer from the electrochemical reporter groups, to the electrode, via the hybridized probe and target DNA, and these anchoring groups in series. Stated differently, these anchoring groups are preferred to have higher conductivities than double-stranded nucleic acid. A conductivity, S, of from between about 10⁻⁶ to about 10⁻⁴ W⁻¹ cm⁻¹, more preferably from about 10⁻⁵ to about 10³ W⁻¹ cm⁻¹, corresponds to a length for the anchoring groups ranging from about 5 Å to about 200 Å.

Alternatively, the primer or probe can be covalently bound onto an intermediate support that is placed on top of the first electrode. The support is preferred to be either a thin layer of porous inorganic material such as TiOx, SiO₂, NOₓ or a porous organic polymer such as polyacrylamide, agarose, nitrocellulose membranes, nylon, and dextran supports. Primers are covalently bound to the support through a linker. Preferred linker moieties include, but are not limited to, thioethers, ethers, esters, amides, amines, hydrazines, carboxylates, halides, hydroxyls, vinyls, vinyl carboxylates, thiols, phosphates, silicon containing organic compounds, and their derivatives and other carboxylate moieties. More preferably, biotin-streptavidin pairs are advantageous arranged to provide probe binding onto the intermediate support.

The apparatus of the invention also includes a second electrode and a reference electrode to permit current flow. The second electrode is most preferably comprised of any conducting material, including, for example, metals such as gold, silver, platinum, copper, and alloys; conductive metal oxides such as indium oxide, indium-tin oxide, zinc oxide; or other conductive materials such as carbon black, conductive epoxy; most preferred is a platinum (Pt)-wire auxiliary electrode. The reference electrode is preferably a silver wire electrode, a silver/silver chloride (Ag/AgCl) reference electrode, or a saturated calomel electrode.

The apparatus also comprises one or a multiplicity of reaction chambers, each reaction chamber being in electrochemical contact with at least one of each of the aforementioned electrodes, wherein each of the electrodes are connected to a power source and a means for controlling said power source. For the purposes of this invention, the term “in electrochemical contact” is intended to mean, inter alia, that the components are connected such that current can flow through the electrodes when a voltage potential is created between the two electrodes.

Electrochemical contact is advantageously provided using an electrolyte solution in contact with each of the electrodes or microelectrode arrays of the invention. Electrolyte solutions useful in the apparatus and methods of the invention include any electrolyte solution at physiologically-relevant ionic strength (equivalent to about 0.15M NaCl) and neutral pH. Nonlimiting examples of electrolyte solutions useful with the apparatus and methods of the invention include but are not limited to phosphate buffered saline, HEPES buffered solutions, and sodium bicarbonate buffered solutions.

Preferred polymerases for performing single base extensions using the methods and apparatus of the invention are polymerases having little or no exonuclease activity. More preferred are polymerases that tolerate and are biosynthetically-active at temperatures greater than physiological temperatures, for example, at 50° C. or 60° C. or 70° C. or are tolerant of temperatures of at least 90° C. to about 95° C. Preferred polymerases include Taq polymerase from T. aquaticus (commercially available from Perkin-Elmer Cetus, Foster City, Calif.), Sequenase® and ThermoSequenase® (commercially available from U.S. Biochemical, Cleveland, Ohio), and Exo(−)Pfu polymerase (commercially available from New England Biolabs, Beverley, Mass.).

The inventive methods for SNP detection provided by the invention generally comprise: (1) preparing a sample containing the target nucleic acid(s) of interest to obtain single-stranded nucleic acid that spans the specific position (typically by denaturing the sample); (2) contacting the single-stranded target nucleic acid with an oligonucleotide primer of known sequence that hybridizes with a portion of the nucleotide sequence in the target nucleic acid immediately adjacent the nucleotide base to be interrogated (thereby forming a duplex between the primer and the target such that the nucleotide base to be interrogated is the first unpaired base in the target immediately 5′ of the nucleotide base annealed with the 3′-end of the primer in the duplex; this oligonucleotide is preferably a specific oligonucleotide occupying a particular address in an addressable array); (3) contacting the duplex with a reagent which includes an aqueous carrier, a polymerase, and at least one primer extension unit, wherein the primer extension unit comprises an extension moiety, an optional linker, and an electrochemical detection moiety. The primer extension reaction catalyzed by the polymerase results in incorporation of the extension moiety of the primer extension unit at the 3′-end of the primer, and the extension of the primer by a single base; (4) removing the unincorporated primer extension unit(s); and (5) determining the identity of the incorporated primer extension unit in the extended duplex by its unique electrochemical detection moiety.

The extension moiety in the primer extension unit is preferably a chain-terminating moiety, most preferably dideoxynucleoside triphosphates (ddNTPs), such as ddATP, ddCTP, ddGTP, and ddTTP; however other terminators known to those skilled in the art, such as nucleotide analogs or arabinoside triphosphates, are also within the scope of the present invention. These ddNTPs differ from conventional deoxynucleoside triphosphates (dNTPs) in that they lack a hydroxyl group at the 3′ position of the sugar component. This prevents chain extension of incorporated ddNTPs, and thus terminates the chain. Unlike conventional detection moieties that have been either fluorescent dyes or radioactive labels, the present invention provides primer extension units labeled with an electrochemical reporter group that are detected electrochemically, most preferably by redox reactions. Any electrochemically-distinctive redox label which does not interfere with the incorporation of the ddNTP into a nucleotide chain is preferred.

Optionally, the target DNA in the sample to be investigated can be amplified by means of in vitro amplification reactions, such as the polymerase chain reaction (PCR) technique well known to those skilled in the art. Enriching the target DNA in a biological sample to be used in the methods of the invention provides more rapid and more accurate template-directed synthesis by the polymerase. The use of such in vitro amplification methods, such as PCR, is optional in the methods of the invention, which feature advantageously distinguishes the instantly-disclosed methods from prior art detection techniques, which typically required such amplification in order to generate sufficient signal to be detected. Because of the increased sensitivity of the instantly-claimed methods, the extensive purification steps required after PCR and other in vitro amplification methods are unnecessary; this simplifies performance of the inventive methods.

Single base extension is performed using a polymerase in the presence of at least one primer extension unit in a buffer solution appropriate for the biochemical activity of the polymerase. A general formula of a preferred embodiment of the primer extension unit is:

ddNTP-L-R

where ddNTP represents a dideoxyribonucleotide triphosphate including ddATP, ddGTP, ddCTP, ddTTP, L represents an optional linker moiety, and R represents an electrochemical reporter group, preferably an electrochemically-active moiety and most preferably a redox moiety.

In preferred embodiments, each chain-terminating nucleotide species (for example, dideoxy(dd)ATP, ddGTP, ddCTP and ddTTP) is labeled with a different electrochemical reporter group, most preferably wherein each different reporter group has a different and electrochemically-distinguishable reduction/oxidation (redox) potential. In this regard, it will be appreciated that nucleotides comprising a DNA molecule are themselves electrically active; for example, guanine and adenine can be electrochemically oxidized around 0.75 V and 1.05 V, respectively. Thus, it is generally preferable for the redox potential of the electrochemical reporter group comprising the primer extension units of the invention to be distinguishable from the intrinsic redox potential of the incorporated nucleotides themselves. The following electrochemical species are non-limiting examples of electrochemically-active moieties provided as electrochemical reporter groups of the present invention, the oxidation (+) potential or reduction (−) potential being listed in the parenthesis (in volt units):

Redox moieties useful against an aqueous saturated calomel reference electrode include 1,4-benzoquinone (−0.54V), ferrocene (+0.307), tetracyanoquinodimethane (+0.127, −0.291), N,N, N′,N′-tetramethyl-p-phenylenediamine (+0.21), tetrathiafulvalene (+0.30).

Redox moieties useful against a Ag/AgCl reference electrode include 9-aminoacridine (+0.85V), acridine orange (+0.830), aclarubicin (+0.774), daunomycin (+0.446), doxorubicin (+0.440), pirarubicin (+0.446), ethidium bromide (+0.678), ethidium monoazide (+0.563), chlortetracycline (+0.650), tetracycline (+0.674), minocycline (+0.385), Hoechst 33258 (+0.586), Hoechst 33342 (+0.571), 7-aminoactinomycin D (+0.651), Chromomycin A₃ (+0.550), mithramycin A (+0.510), Vinblastine (+0.522), Rifampicin (+0.103), Os(bipyridine)₂(dipyridophenazine)²⁺(+0.72), Co(bipyridine)₃³⁺(+0.11), Fe-bleomycin (−0.08)

(The redox data are from Bard & Faulkner, 1980, ELECTROCHEMICAL METHODS, John Wiley & Sons, Inc. and Hshimoto et al., 1994, Analytica Chimica Acta. 286: 219-224).

The choice of the electrochemically-active moiety comprising the electrochemical reporter groups of the invention is optimized for detection of the moiety to the exclusion of other redox moieties present in the solution. as well as to prevent interference of the label with hybridization between an oligonucleotide contained in an array and a nucleic acid comprising a biological sample.

The electrochemically-active moiety comprising the chain-terminating nucleotides of the invention is optionally linked to the extension nucleotide through a linker (L), preferably having a length of from about 10 to about 20 Angstroms. The linker can be an organic moiety such as a hydrocarbon chain (CH₂)ₙ, or can comprise an ether, ester, carboxyamide, or thioether moiety, or a combination thereof. The linker can also be an inorganic moiety such as siloxane (O—Si—O). The length of the linker is selected so that R, the electrochemically-active moiety, does not interfere with either nucleic acid hybridization between the bound oligonucleotide primer and target nucleic acid, or with polymerase-mediated chain extension.

In preferred embodiments, single base extension is detected by standard electrochemical means such as cyclic voltammetry (CV) or stripping voltammetry. In a non-limiting example, electric current is recorded as a function of sweeping voltage to the first electrode specific for each particular labeled primer extension unit. The incorporation and extension of a specific base is identified by the unique oxidation or reduction peak of the primer extension unit detected as current flow in the electrode at the appropriate redox potential.

In additional embodiments, other electric or/and electrochemical methods useful in the practice of the methods and apparatus of the invention include, but are not limited to, AC impedance, pulse voltammetry, square wave voltammetry, AC voltammetry (ACV), hydrodynamic modulation voltammetry, potential step method, potentiometric measurements, amperometric measurements, current step method, and combinations thereof. In all these methods, electric current is recorded as a function of sweeping voltage to the first electrode specific for each particular labeled primer extension unit. The difference is the type of input/probe signal and/or shape of input/probe signal used to sweep the voltage range. For example, in cyclic voltammetry, a DC voltage sweep is done. In ACV, an AC signal is superimposed on to the voltage sweep. In square wave voltammetry, a square wave is superimposed on to the voltage sweep. Most preferably, the signal is recorded from each position (“address”) in the oligonucieotide array, so that the identity of the extended species can be determined. The identity of the nucleotide comprising the extension unit is determined from the redox potential at which current flow is detected.

In the use of the apparatus of the invention to perform a single base extension reaction, a reaction mixture is prepared containing at least one chain-terminating nucleotide labeled with an electrochemical label (such as a redox-labeled ddNTP), a hybridization buffer compatible with the polymerase and having a salt concentration sufficient to permit hybridization between the target nucleic acid and primer oligonucleotides under the conditions of the assay, and a DNA polymerase such as Taq DNA polymerase or ThermoSequenase. Single stranded target nucleic acid, for example, having been denatured by incubation at a temperature >90° C., is diluted to a concentration appropriate for hybridization in deionized water and added to the reaction mixture. The resulting hybridization mixture is sealed in a reaction chamber of the apparatus of the invention containing a first electrode, wherein the electrode comprises a multiplicity of primers having known sequence linked thereto. At least one of the primers has a nucleotide sequence capable of hybridizing with a portion of the nucleotide sequence of the target immediately adjacent the nucleotide base to be interrogated under the hybridization conditions employed in the assay.

A duplex between the primer and the target is formed wherein the nucleotide base to be interrogated is the first unpaired base in the target immediately 5′ of the nucleotide base that is annealed with the 3′-end of the primer in the duplex. Single base extension of the 3′ end of the annealed primer is achieved by incorporation of the chain-terminating nucleotide, labeled with an electrochemically active moiety, into the primer. The primer sequence and labeled chain-terminating nucleotide are chosen so that incorporation of the nucleotide is informative of the identity (i.e., mutant, wildtype or polymorphism) of the interrogated nucleotide in the target.

Alternatively, the probe comprises a 3′ terminal residue that corresponds to and hybridizes with the interrogated base. In these embodiments, oligonucleotides having a “mismatch” at the 3′ terminal residue will hybridize but will not be extended by the polymerase. Detection of incorporation of the primer extension unit by interrogating the redox label is then informative of the identity of the interrogated nucleotide base, provided that the sequence of the oligonucleotide probe is known at each position in the array.

After the SBE reaction is performed, the electrode is washed at high stringency (i.e., in a low-salt and low dielectric constant solution (such as 0.1×SSC: 0.015M NaCl, 15 mM sodium citrate, pH 7.0), optionally including a detergent such as sodium dodecyl sulfate at temperature of between about 10-65° C.) for a time and at a temperature wherein the target nucleic acid is removed. Wash conditions vary depending on factors such as probe length and probe complexity. Electrochemical detection is carried out in an electrolyte solution by conventional cyclic voltammetry.

The following examples serve to more fully describe the manner of using the above-described invention, as well as to set forth the best modes contemplated for carrying out various aspects of the invention. It is understood that these examples in no way serve to limit the true scope of this invention, but rather are presented for illustrative purposes. All references cited herein are incorporated by reference.

### EXAMPLES

### Example 1

### Preparation of Polypyrrole Microelectrodes

Polypyrrole microelectrodes were prepared as follows. Ultra-fine platinum wire having a diameter of 50 mm was inserted into glass capillary tubing having a diameter of 2 mm and sealed by heating to form a solid microelectrode structure. The tip of the structure was then polished with gamma alumina powder (CH Instruments, Inc., Austin, Tex.) to expose a flat disk of the platinum wire. Microelectrodes were initially polished with 0.3 mm gamma alumina powder, rinsed with deionized water, and then polished with 0.005 mm powder. Following polishing, the microelectrodes were ultrasonically cleaned for 2 min. in deionized water, soaked in 1 N HNO₃ for 20 min., vigorously washed in deionized water, immersed in acetone for 10 min., and again washed vigorously in deionized water. Through the use of micromanufacturing techniques employed in the fabrication of semiconductors, modifications of this procedure can be applied to the preparation of microelectrodes of a size required for the construction of bioarray chips.

A neutral polypyrrole matrix was used for attachment of nucleic acid probes to the exposed platinum disk of the microelectrodes. Electrochemical deposition was performed using a model 660A potentiostat (CH Instruments, Inc.), using platinum wire as a counter-electrode, silver/silver chloride (Ag/AgCl) as a reference electrode, and cyclic voltammetry (CV). A solution containing 0.05 M pyrrole, 2.5 mM 3-acetate-N-hydrodysuccinimido pyrrole, and 0.1 M LiClO₄/95% acetonitrile was prepared as the electrolyte. The potential range for the CV was 0.2 to 1.3 V versus Ag/AgCl for the first cycle and −0.1 to 1.0 versus Ag/AgCl for 10 additional cycles. The scan rate was 10 mV/sec. The electrolyte was purged by nitrogen gas during the entire deposition process. Alternatively, polypyrrole film can be formed by oxidation of pyrrole at a constant current of 0.20 to 0.25 mA/cm² in the same solution described above. This method is more convenient to make array-based microelectrodes since the reference electrode is not required. An electrochemical oxidation of the pyrrole produced the polypyrrole shown to the right of the arrow in FIG. 2A.

The polypyrrole electrodes in oxidized form were put into 0.1 M LiClO₄ and cycled over a potential range of −0.1 to 0.8 for 20 cycles. This procedure stabilizes the polypyrrole film. To make a neutralized polypyrrole, the microelectrodes were placed in the electrolyte again and cycled for 10 cycles over a potential range of −0.2 to 0.3 versus Ag/AgCl, which is the reduction zone for this electrochemical system. The neutralization is desired in order to reduce the background charge of the probe attachment matrix and thus increase the sensitivity of the hybridization electrical measurements. The reaction for neutralizing the polypyrrole film is illustrated in FIG. 2B. Following neutralization of the polypyrrole film coating the microelectrodes, the microelectrodes were vigorously rinsed with deionized water.

### Example 2

### Attachment of Nucleic Acid Probes to Polypyrrole Microelectrodes

To attach nucleic acid probes to the microelectrodes prepared in Example 1, the microelectrodes were incubated at room temperature for 4 hours in a solution consisting of 80 mL dimethylformamide and 20 mL of 15 nM 5′-amino labeled 15-mer oligonucleotide (5′-C-C-C-T-C-A-A-G-C-A-G-A-G-G-A-3′; SEQ ID NO: 1). Following attachment of the probe molecules, the microelectrodes were washed with TBE buffer (0.89 M Tris-borate, 0.025 M EDTA), rinsed thoroughly in deionized water, and allowed to dry at room temperature.

### Example 3

### Electrical Detection of Nucleic Acid Hybridization Using Polypyrrole Microelectrodes

The AC impedance baseline of the microelectrodes prepared according to Example 2 was first determined in the absence of a complementary target molecule. Microelectrodes were then exposed in a sealed conical tube to 35 mL of the complementary target molecule (5′-T-C-C-T-C-T-G-C-T-T-G-A-G-G-G-3′; SEQ ID NO: 2) present at concentrations in the micromolar (10⁻⁶ M; mM) to attomolar (10⁻¹⁸ M; aM) range. Hybridization of probe and target molecules was performed in 1×SSC buffer (0.15 M NaCl, 0.015 M sodium citrate, pH 7.0) at 37° C. for 24 to 48 hours. Following hybridization, microelectrodes were thoroughly rinsed in an excess volume of 1×SSC at room temperature and then AC impedance was measured.

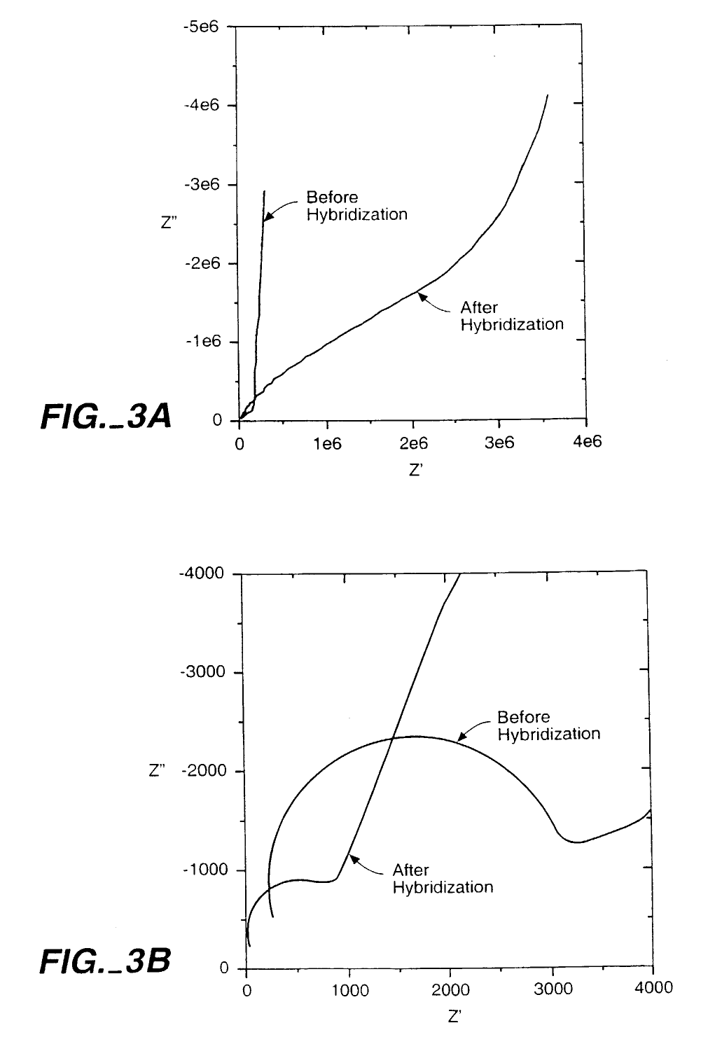

AC impedance was measured using a model 1260 Impedance/Gain-Phase Analyser with model 1287 Electrochemical Interface (Solartron Inc, Houston, Tex.). The counter and reference electrodes were platinum and Ag/AgCl, respectively, and the impedance measurements were made under open circuit voltage (OCV) conditions in a 1 M LiClO₄ solution. The measured complex impedance (Z) versus frequency for a polypyrrole microelectrode with attached 15-mer oligonucleotide before and after hybridization with a 2 fM solution of the complementary target molecule is shown in FIG. 3A (Complex impedance is described by the equation Z=Z′+iZ″, in which Z′ is real part of the impedance, i is Ö-1 and Z″ is imaginary part of the impedance). A significant difference was observed between the microelectrodes before and after hybridization to the target molecule (FIG. 3A). The large signals produced at low target concentration (i.e., 2 fM of target is equivalent to 0.1 amol of target molecules) indicates the high sensitivity of the methods of the present invention for detecting hybridization between oligonucleotide probes and target nucleic acid molecules. The frequency increases from 0.1 Hz at large values of Z′ to 1 MHz at a Z′ of ˜0.

FIG. 3B illustrates the frequency complex curves, as seen in FIG. 3A, for the high frequency zone (where Z′<5×10⁴). Frequency dependent semicircle impedance curves were observed at high frequencies before and after hybridization. Generally, such curves at high frequencies indicate the existence of a Faraday resistance (i.e., electrochemical reaction resistance) in parallel with a capacitance. Semicircular curves such as those shown in FIG. 3B can be used to obtain the electrochemical reaction resistance and the double layer capacitance by equivalent circuit simulation. The simulation results obtained using the data shown in FIG. 3B is shown in Table I. These results indicate that following hybridization of the probe and target molecules, the high frequency electrochemical resistance decreases and the capacitance increases, which is as expected. This demonstrates that the hybridized DNA has a strong electrochemical interactions with Li⁺.

TABLE I
Equivalent Circuit Parameters Obtained
from High Frequency Impedance Data

| Nucleic Acid Status | Faraday Resistance, R (W) | Capacitance, C (nF) |
|---|---|---|
| Single-stranded | 2236 | 0.198 |
| Double-stranded | 922 | 0.597 |

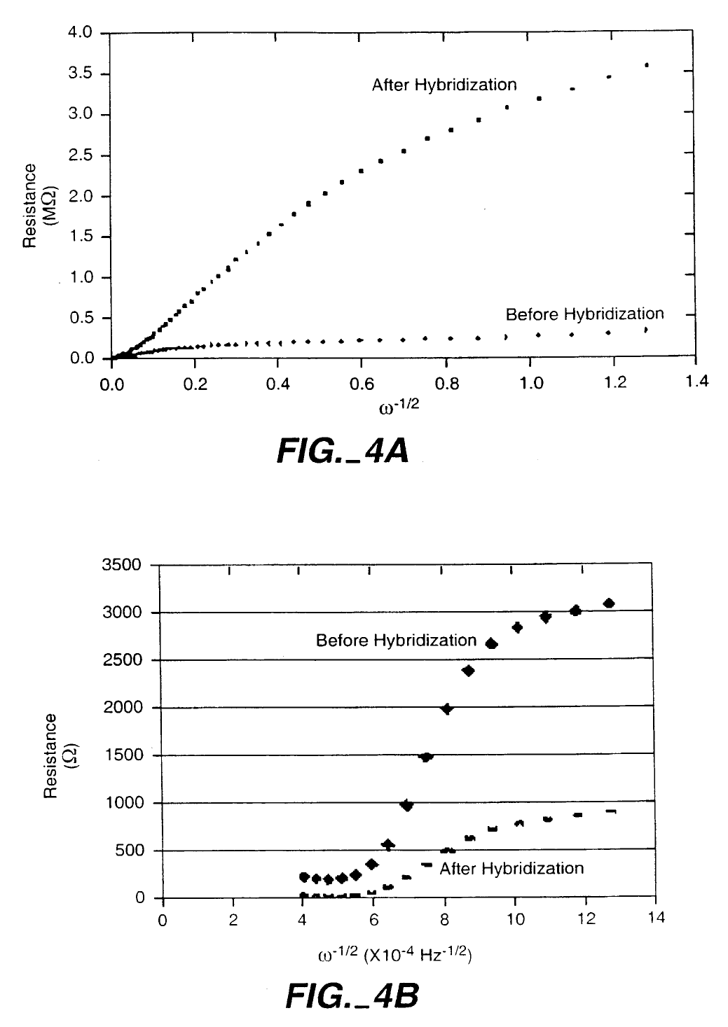

The real part of the complex impedance data shown in FIG. 3A, i.e., the resistance (R) versus the square root of the frequency (w^{-1/2}), is plotted in FIGS. 4A and 4B. Linear regions are observed, demonstrating that the Li⁺ diffusion process dominates the measurements at lower frequencies. FIGS. 4A and 4B show that a significant change in the resistance occurs after hybridization of the single-stranded probe with the target molecule. The decrease in high frequency resistance following hybridization (FIG. 4B) can be explained by a decrease in the Faraday resistance of the hybridized nucleic acid. At low frequencies, the large ion diffusion resistance dominates the impedance and thus the resistance is higher for the hybridized probe-target duplex (FIG. 4A). As the frequency increases, the contribution of the frequency-dependent diffusion resistance decreases and thus the smaller Faraday resistance dominates.

The limit of detection in the experiments described above was reached at approximately 0.1 attomol of target molecule. With increased target molecule concentrations, higher hybridization signals were obtained, demonstrating that methods of the present invention can be also used to quantify the amount of target hybridized onto the electrode-immobilized probe. Thus, this method can be used in conjunction with appropriate reference electrodes to measure the absolute quantities of nucleic acid in a test sample. For example, the methods of the present invention enable one to perform high sensitivity, high resolution measurements of RNA concentrations in gene expression studies. Comparative gene expression studies performed using such a method permits the direct measurement of the quantity of expressed RNA, rather than relying on a determination of the ratio between the RNA of interest and a control RNA.

### Example 4

### Specificity of Electrical Detection Using Polypyrrole Microelectrodes

Microelectrodes with attached oligonucleotide probes were prepared as described in Examples 1 and 2. Four microelectrodes were incubated in a solution containing 2 pM of a 15-mer target molecule that was fully complementary to the attached probe (5′-T-C-C-T-C-T-G-C-T-T-G-A-G-G-G-3′; SEQ ID NO: 2) and four other microelectrodes were incubated in a solution containing 2 fM of a 15-mer target molecule containing three mismatched bases relative to the attached probe (5′-C-C-C-T-C-A-A-G-C-A-G-A-G-G-A-3′; SEQ ID NO: 1) using the conditions described in Example 3.

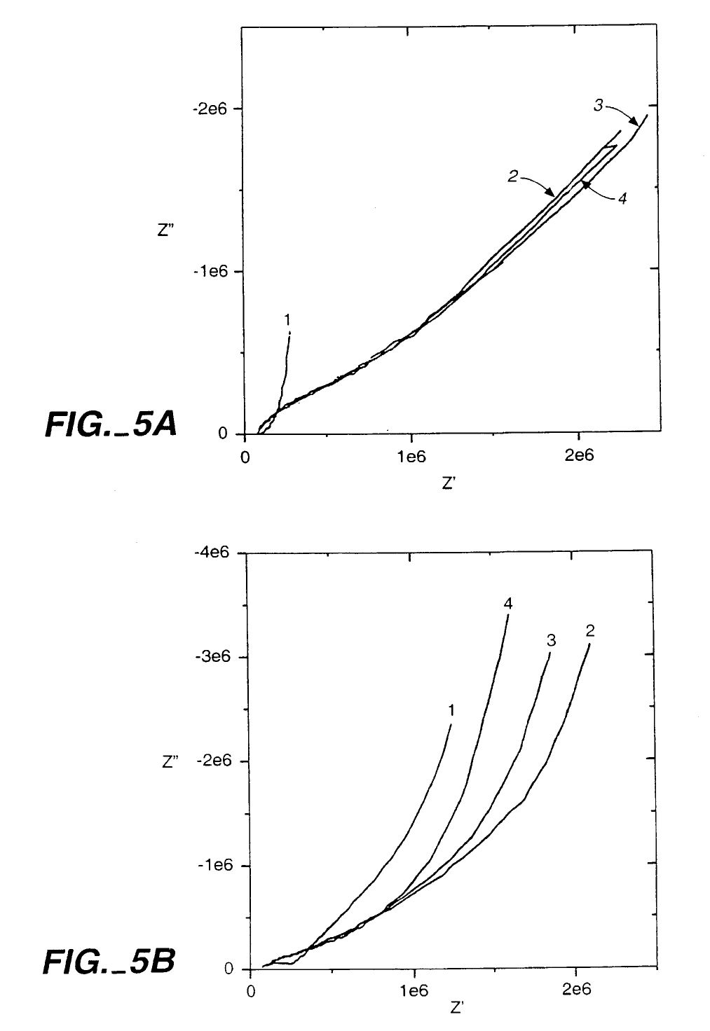

Following hybridization, individual microelectrodes were washed at successively higher temperatures to electrically measure the melting of the duplexes. Washing was performed by placing the microelectrodes in 1×SSC for 30 min. at either 37° C. or 38° C. AC impedance curves for the microelectrodes that were not hybridized, hybridized to the target, or washed at 37° C. or 38° C. are shown in FIGS. 5A (fully complementary target molecule) and 5B (mismatched target molecule).

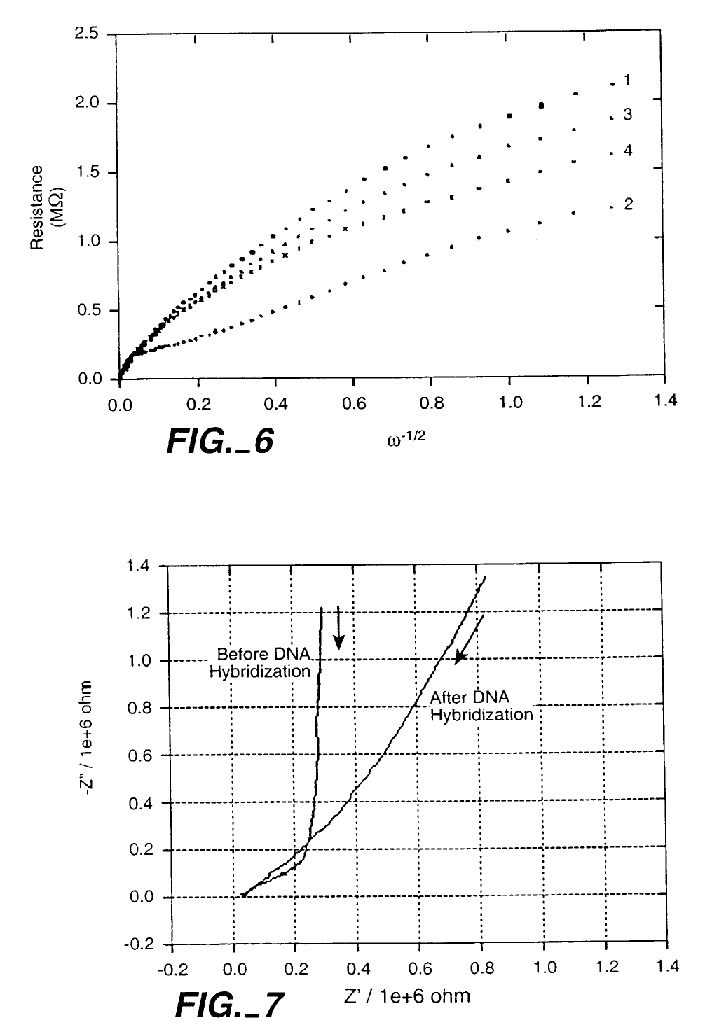

AC impedance measurements showed a pronounced difference between the fully complementary (perfect) and mismatched hybridized nucleic acid duplexes. The impedance curves obtained for the fully complementary target molecule remained unchanged following the washes, indicating that the melting temperature of the perfect duplex was not exceeded. The impedance curves obtained for the mismatched target molecule moved toward the baseline (i.e., unhybridized probe) following washes, indicating that the melting of this duplex was occurring at temperatures near to that duplexes melting temperature. The ability to discriminate between matched and mismatched nucleic acid sequences demonstrates the applicability of the methods of the present invention in the detection of gene polymorphism. FIG. 6 indicates that the resistance in the mismatched DNA system continuously decreases with increasing wash temperature going back to the baseline of the single-stranded DNA.

### Example 5

### Use of Li⁺ Reporter in Polypyrrole Microelectrode Electrical Detection of Molecular Interactions

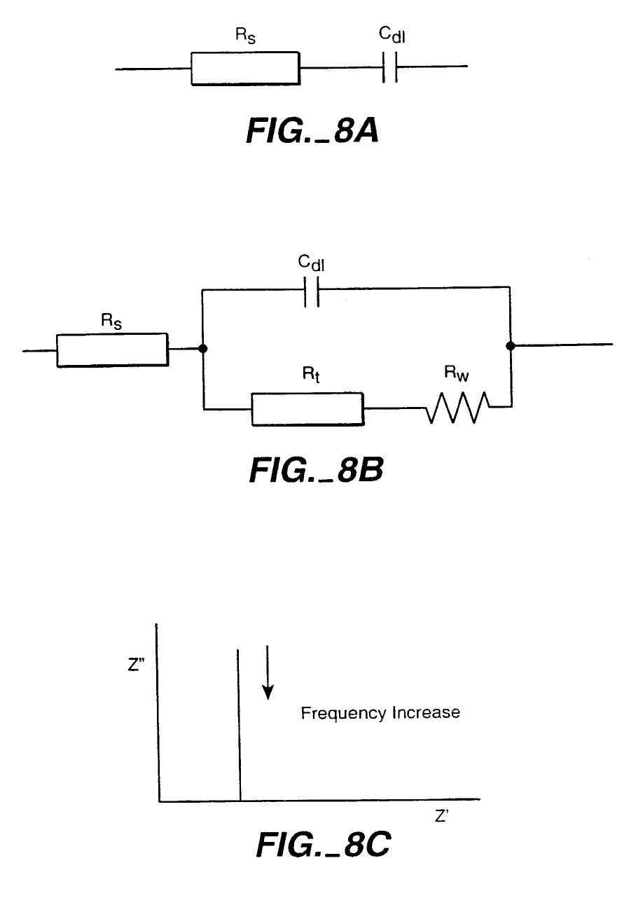

Microelectrodes were prepared as described in Examples 1 and 2 and were hybridized to suitable target molecules as described in Example 3. The AC impedance before and after nucleic acid hybridization is shown in FIG. 7. The microelectrode with attached oligonucleotide probe exhibits the characteristics of an ideal polarization electrode prior to hybridization with a target molecule. The equivalent circuit for this state is shown in FIG. 8A and the AC impedance response is shown in FIG. 8B. In this state, the microelectrode can be described by the equation: Z=Rₛ−j(wC_{dl})⁻¹, where Z is impedance, Rₛ is solution resistance, j=Ö-1, w is 2, and C_{dl} is double layer capacitance.

The behavior of the microelectrode is treated as an “ideal” polarization electrode under conditions of an electrolyte solution comprising 0.1 M LiClO₄ with purging N₂ and before hybridization to a suitable target molecule is reasonable since there is no electrochemically active species and no specific adsorption. However, following hybridization to a suitable target molecule, a large deviation from the ideal curve was observed in the same electrolyte, indicating that the impedance was significantly increased. The AC impedance measured for the microelectrode following hybridization suggests that the electrochemical process and equivalent circuit under such conditions is as shown in FIG. 8C (where Rₜ is the Faraday resistance, i.e., electrochemical reaction resistance and R_{w} is Warburg resistance). Resistance from both electrochemical reactions and the diffusion process causes the electrode behavior following hybridization to deviate from the ideal polarization curve.

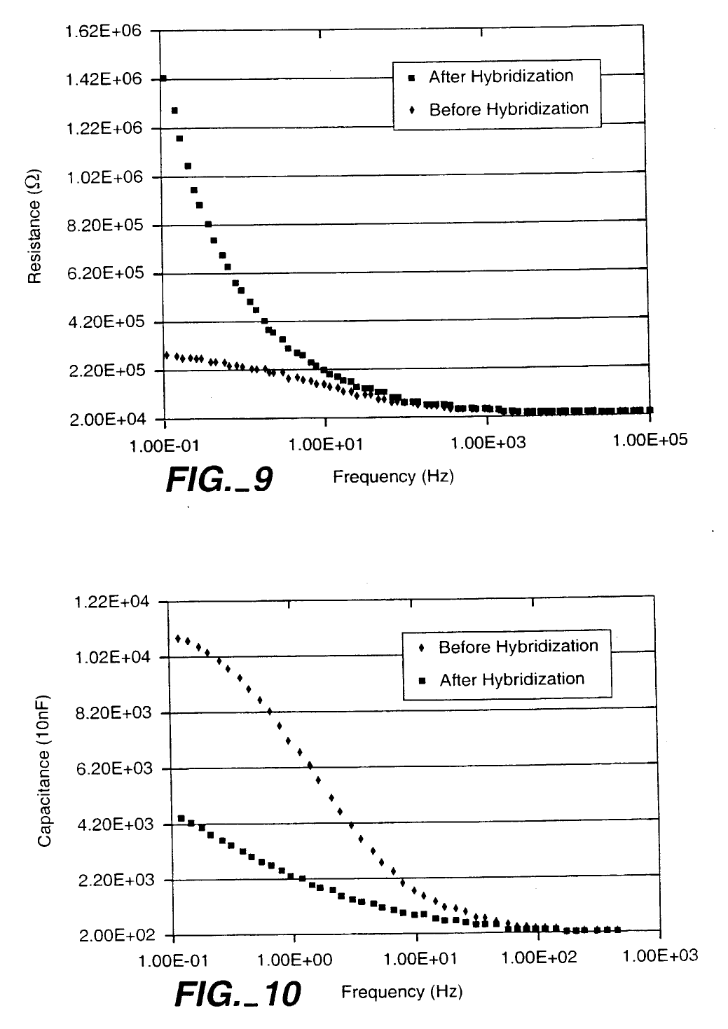

While simulation would enable the calculation of all the parameters in the equivalent circuit for this state, the equivalent circuit can also be simplified for R and C. The results of such simplification are shown in FIGS. 9 and 10, indicating that the resistance from both R and C increases as one order of magnitude. The results of the experiments described above (particularly those described in Example 4) indicate that Li⁺ in the electrolyte can serve as a reporter, permitting the mismatches between probes and target molecules to be detected. Since a method of the present invention relies on the intercalation or binding of cations, more preferably Li⁺ cations, to enable electrical detection, this method does not require that target molecules be labeled.

### Example 6

### Preparation of Hydrogel Porous Microelectrodes

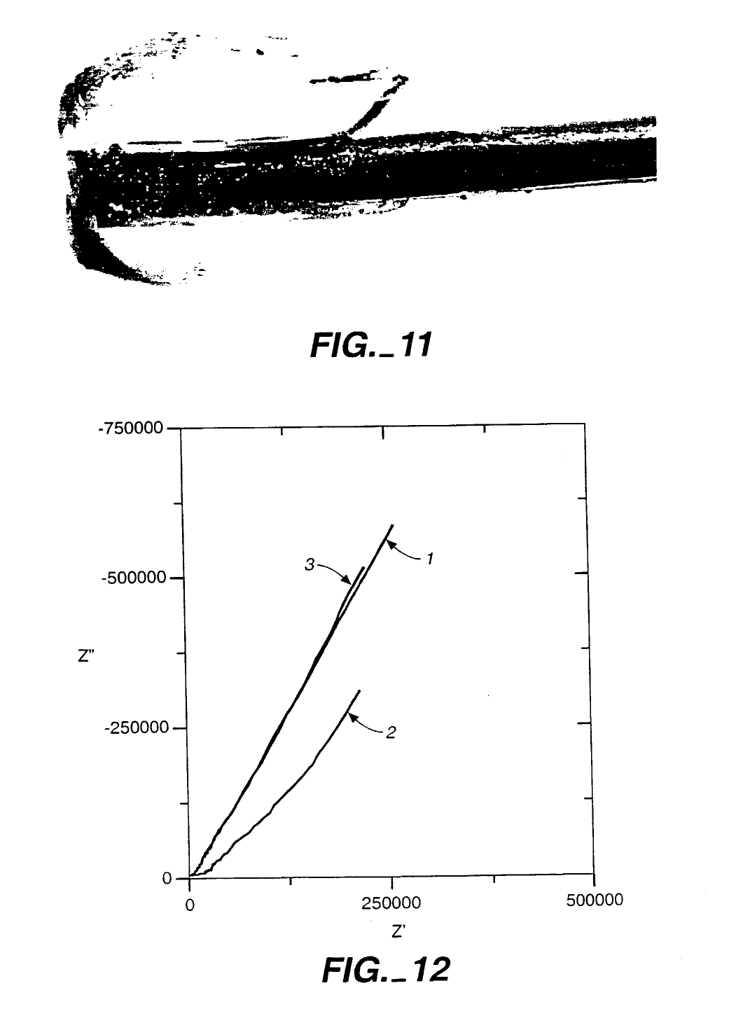

Microelectrodes were prepared as described in Example 1 (FIG. 1A). The exposed flat disk of platinum was then etched in hot aqua regia to form a recess (i.e., micropore dent) of a specified depth. The depth of the recess was controlled by the length of time that the platinum disk was exposed to the etching material. The recess thus formed was then packed with polyacrylamide gel material (FIG. 1B) to form a hydrogel porous microelectrode (FIG. 11). A hydrogel porous microelectrode having a diameter of 258 mm was used in the following Examples.

Prior to attachment of probe molecules, hydrogel porous microelectrodes were activated by incubation for 10 min. in 2% trifluoroacetic acid, and rinsed for 2 min. in deionized water. Microelectrodes were then incubated for 15 min. in 0.1 M sodium periodate, and rinsed for 2 min. in deionized water. Following this treatment, microelectrodes were thoroughly washed by incubation in deionized water for 15 min., and then air-dried. Microelectrodes were subsequently incubated for 10 min. in 2% dimethyl dichlorosilane solution and 2% octamethylcyclotetrasiloxane, washed in ethanol, rinsed in deionized water, and air-dried.

### Example 7

### Attachment of Nucleic Acid Probes to Hydrogel Porous Microelectrodes

To attach nucleic acid probes to the microelectrodes prepared in Example 6, the microelectrodes were incubated at room temperature for 4 hours in a solution consisting of 80 mL dimethylformamide and 20 mL of 2 pM 5′-amino-3′fluorescein labeled 15-mer oligonucleotide (5′-C-C-C-T-C-A-A-G-C-A-G-A-G-G-A-3′; SEQ ID NO: 1). Following attachment of the probe molecules, the microelectrodes were washed with TBE buffer, rinsed thoroughly in deionized water, and allowed to dry at room temperature.

### Example 8

### Electrical Detection of Nucleic Acid Hybridization Using Hydrogel Porous Microelectrodes

The baseline AC impedance of hydrogel porous microelectrodes prepared according to Example 7 was first determined in the absence of target molecules. Microelectrodes were then exposed in a sealed conical tube to either 35 mL of a complementary target molecule (5′-T-C-C-T-C-T-G-C-T-T-G-A-G-G-G-3′; SEQ ID NO: 2) present at a concentration of either 2 pM or 35 mL of a mismatched target molecule (5′-C-C-C-T-C-A-A-G-C-A-G-A-G-G-A-3′; SEQ ID NO: 1) present at a concentration of 300 nM. Hybridization of the probe with either target molecule was performed in 1×SSC buffer at room temperature for 1 hour. Following hybridization, microelectrodes were thoroughly rinsed for 20 min. at room temperature in an excess volume of 1×SSC and then AC impedance was measured.

AC impedance was measured using a model 1260 Impedance/Gain-Phase Analyser with model 1287 Electrochemical Interface. The counter and reference electrodes were platinum and Ag/AgCl, respectively, and the impedance measurements were made under open circuit voltage (OCV) conditions in 1×SSC hybridization solution. Samples were excited at an amplitude of 50 mV. The measured complex impedance (Z) versus frequency for the hydrogel porous microelectrode with attached 15-mer oligonucleotide following hybridization with the complementary target molecule or mismatched target molecule is shown in FIG. 12.

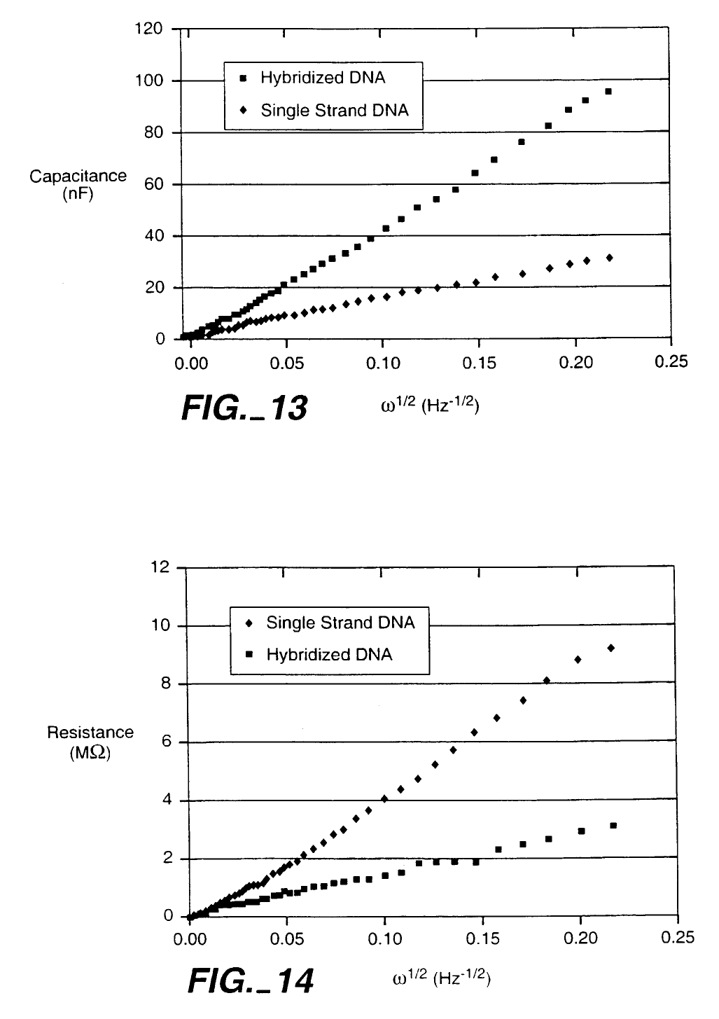

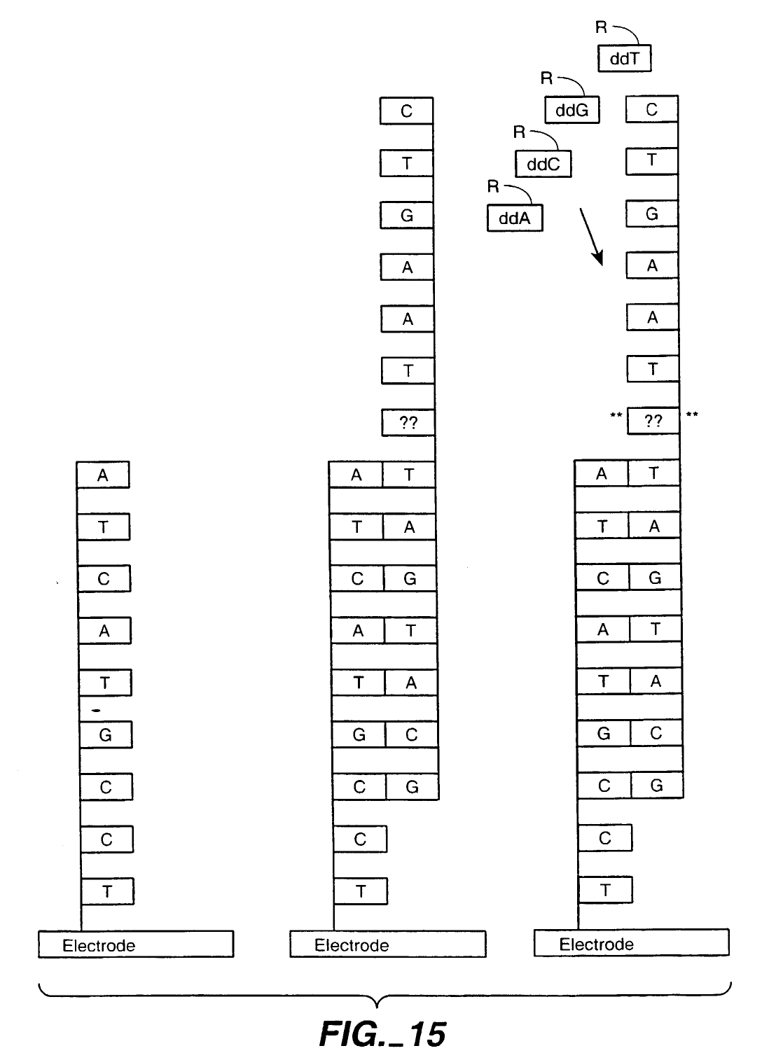

The signal generated following hybridization of probe molecules with a mismatched target molecule was indistinguishable from the signal generated in the absence of target molecule. The results, as shown in FIG. 12, indicate that the charge transfer has diffusion control at lower frequencies. The diffusion impedance is expressed as the Warburg element, W, and has a linear region in plots of both imaginary and real parts vs. w^{-1/2}. From the imaginary and real parts of the complex impedance data shown in FIG. 12, plots of resistance (R) vs. w^{-1/2} and of capacitance (C) vs. w^{-1/2} were extracted and plotted as shown in FIGS. 13 and 14. Linear regions are observed in these plots, proving that a diffusion process dominates the electronic measurements. These plots show that both resistance and capacitance exhibit a significant change after the hybridization of the single stranded DNA probe with the target DNA. The resistance decreases and the capacitance increases following hybridization. These results indicate that the hybridization of target molecules to probe molecules attached to the polyacrylamide gel can improve the charge transfer process by decreasing the resistance. The increase in capacitance is due to the increase in the surface charge as a result of nucleic acid hybridization. The results obtained with the hydrogel porous microelectrode demonstrate that such microelectrodes can be used to detect 40 fmol of target molecule in solution.

### Example 9

### Preparation of Hydrogel Porous Microelectrodes

Microelectrodes were prepared as follows. Ultra-fine platinum wire having a diameter of 50 mm was inserted into glass capillary tubing having a diameter of 2 mm and sealed by heating to form a solid microelectrode structure. The tip of the structure was then polished with gamma alumina powder (CH Instruments, Inc., Austin, Tex.) to expose a flat disk of the platinum wire. Microelectrodes were initially polished with 0.3 mm gamma alumina powder, rinsed with deionized water, and then polished with 0.005 mm powder. Following polishing, the microelectrodes were ultrasonically cleaned for 2 min. in deionized water, soaked in 1 N HNO₃ for 20 min., vigorously washed in deionized water, immersed in acetone for 10 min., and again washed vigorously in deionized water. Through the use of micromanufacturing techniques employed in the fabrication of semiconductors, modifications of this procedure can be applied to the preparation of microelectrodes of a size required for the construction of bioarray chips.

Hydrogel porous microelectrodes were prepared from the above-described microelectrodes as follows. The exposed flat disk of platinum of each microelectrode was etched in hot aqua regia to form a recess (i.e., micropore dent) of a specified depth. The depth of the recess was controlled by the length of time that the platinum disk was exposed to the etching material. The recess thus formed was then packed with polyacrylamide gel material (FIG. 1B) to form a hydrogel porous microelectrode (FIG. 2). A hydrogel porous microelectrode having a diameter of 258 mm was used in the Example 2.

Prior to attachment of probe molecules, hydrogel porous microelectrodes were activated by incubation for 10 min. in 2% trifluoroacetic acid, and rinsed for 2 min. in deionized water. Microelectrodes were then incubated for 15 min. in 0.1 M sodium periodate, and rinsed for 2 min. in deionized water. Following this treatment, microelectrodes were thoroughly washed by incubation in deionized water for 15 min., and then air-dried. Microelectrodes were subsequently incubated for 10 min. in 2% dimethyl dichlorosilane solution and 2% octamethylcyclotetrasiloxane, washed in ethanol, rinsed in deionized water, and air-dried.

### Example 10

### Attachment of Nucleic Acid Probes to Hydrogel Porous Microelectrodes

To attach nucleic acid probes to the microelectrodes prepared in Example 1, the microelectrodes were incubated at room temperature for 4 hours in a solution consisting of 80 mL dimethylformamide and 20 mL of 2 pM 5′-amino-3′fluorescein labeled 15-mer oligonucleotide (5′-C-C-C-T-C-A-A-G-C-A-G-A-G-G-A-3′; SEQ ID NO: 1). Following attachment of the probe molecules, the microelectrodes were washed with TBE buffer, rinsed thoroughly in deionized water, and allowed to dry at room temperature.

### Example 11

### Electrochemical Detection of Nucleic Acid Hybridization

Nucleic acid hybridization between a probe bound to a hydrogel porous microelectrode and an electrochemically-labeled target molecule is detected as follows. The baseline AC impedance of hydrogel porous microelectrodes prepared according to Example 2 is first determined in the absence of the electrochemically-labeled target molecules. Microelectrodes are then exposed in a sealed conical tube to either 35 mL of a complementary target molecule (5′-T-C-C-T-C-T-G-C-T-T-G-A-G-G-G-3′; SEQ ID NO: 2) present at a concentration of either 2 pM or 35 mL of a mismatched target molecule (5′-C-C-C-T-C-A-A-G-C-A-G-A-G-G-A-3′; SEQ ID NO: 1 present at a concentration of 300 nM. Hybridization of the probe with either target molecule is performed in 1×SSC buffer at room temperature for 1 hour. Following hybridization, microelectrodes are thoroughly rinsed for 20 min. at room temperature in an excess volume of 1×SSC and then AC impedance is measured.

AC impedance is measured using a model 1260 Impedance/Gain-Phase Analyser with model 1287 Electrochemical Interface. The counter and reference electrodes are platinum and Ag/AgCl, respectively, and the impedance measurements are made under open circuit voltage (OCV) conditions in 1×SSC hybridization solution. Samples are excited at an amplitude of 50 mV. The complex impedance (Z) versus frequency for the hydrogel porous microelectrode with attached 15-mer oligonucleotide following hybridization with the complementary target molecule or mismatched target molecule is then determined.

### Example 12

### Single Base Extension

An apparatus of the invention is produced as follows. A glass substrate layer is prepared comprising an ordered array of a plurality of gold microelectrodes connected to a voltage source. The substrate has a surface area of 100 mm² and contains 10⁴ microelectrodes, each microelectrode in contact with a polyacrylamide gel pad that is about 0.5 μm thick to which an oligonucleotide having a particular sequence has been immobilized thereto. The microelectrodes are arranged on the substrate so as to be separated by a distance of about 0.1 mm, and are regularly spaced on the solid substrate with a uniform spacing there between.

To each of the gold electrodes is affixed an oligonucleotide probe having a length of 25 nucleotides. The resulting ordered array of probes are arranged in groups of four, whereby the probes are identical except for the last (most 3′) residue. Each group contains an oligonucleotide ending in an adenosine (A), guanine (G), cytosine (C) or thymidine (T) or uracil (U) residue. The oligonucleotides are attached to each of the gold electrodes through the polyacrylamide gel pad using a modification of the oligonucleotide at the 5′ residue. This residue comprises a thioester linkage that covalently attaches the oligonucleotide to the polyacrylamide polymer.

This ordered microelectrode array is placed in a reaction chamber, having dimensions sufficient to contain the array and a volume of from about 10 to 100 mL of hybridization/extension buffer. The reaction chamber also comprises a second counter electrode comprising platinum wire and a third, reference electrode that is a silver/silver chloride electrode, each electrode being electrically connected to a voltage source.

In the use of the apparatus of the invention, a volume of from about 10 to 100 mL of hybridization buffer is added to the reaction chamber. This solution also contains a target molecule, typically at concentrations in the micromolar (10⁻⁶ M; μM ) to attomolar (10⁻¹⁸ M; aM) range. Hybridization of probe and target molecules is performed in 1×SSC buffer (0.15 M NaCl, 0.015 M sodium citrate, pH 7.0) at 37° C. for 24 to 48 hours. Following hybridization, microelectrodes were thoroughly rinsed in an excess volume of 1×SSC at room temperature.

A volume of from about 10 to 100 mL of extension buffer containing a polymerase and a plurality of each of 4 chain-terminating nucleotide species is then added to the reaction chamber. Each of the four chain-terminating nucleotide species is labeled with a chemical species capable of participating in a reduction/oxidation (redox) reaction at the surface of the microelectrode. An example of such a collection of species is: ddATP labeled with cobalt (bipyridine)₃³⁺; ddGTP labeled with minocycline; ddCTP labeled with acridine orange; and ddTTP labeled with ethidium monoazide. The redox labels are covalently linked to the chain-terminating nucleotides by a hydrocarbon linker (CH₂)₂₋₈. The extension buffer is chosen to accommodate the polymerase, such as Thermosequenase (obtained from U.S. Biochemicals, Cleveland, Ohio). The extension reaction is performed at a temperature appropriate for the polymerase, such as about 65° C., that does not denature the hybridized duplex between the target and the oligonucleotide probes, and for a time sufficient for the extension reaction to go to completion. After the extension reaction is complete, the array is washed at high stringency in 0.1×SSC/1% SDS at a temperature that does not denature the hybridized duplex.

After washing, a volume of about 10 to 100 mL of an electrolyte solution is added to the reaction chamber, and each microelectrode is interrogated by conventional cyclic voltammetry to detect a redox signal. The identity of oligonucleotides containing single base extended species is determined by the redox potential of the signal obtained thereby.

Equivalently, hybridization and single base extension can be performed in the same buffer solution, provided the polymerase is compatible with the hybridization buffer conditions.

We claim:

1. An apparatus for electric or electrochemical detection of molecular interactions between an immobilized probe and an electrochemically active reporter-labeled target molecule, comprising:
(a) a supporting substrate,
(b) a plurality of microelectrodes in contact with the supporting substrate,
(c) a plurality of polymeric hydrogel pads in contact with the microelectrodes and to which probes are immobilized,
(d) at least one counter-electrode in contact with the supporting substrate,
(e) a means for producing an electrical signal at each microelectrode,
(f) a means for detecting changes in the electrical signal at each microelectrode, and
(g) an electrolyte solution in contact with the plurality of microelectrodes and polymeric hydrogel pads, and the counter-electrode, wherein molecular interactions between the immobilized probe and the electrochemically active reporter-labeled target molecule are detected by detecting changes in the electrical signal in the presence or absence of the electrochemically active reporter-labeled target molecule.

2. An apparatus for detecting single base extension of an oligonucleotide comprising an oligonucleotide array, wherein extension is effected by a polymerase and directed by a nucleotide sequence of a nucleic acid in a biological sample, the apparatus comprising
a first electrode comprising an array of oligonucleotides on a substrate, wherein the electrode comprises a conducting or semiconducting surface,
a second, counter electrode comprising a conducting metal in contact with an aqueous electrolyte solution, and
a third reference electrode in contact with the aqueous electrolyte solution,
wherein each of the electrodes is electrically connected to a voltage source, and wherein the apparatus further comprises
a reaction chamber containing a polymerase and a hybridization solution comprising an electrolyte, wherein each of the electrodes is in electrochemical contact therewith, the solution further containing
a plurality of primer extension units comprising chain-terminating nucleotide species, wherein each different chain-terminating nucleotide species is labeled with a distinguishable electrochemical label capable of participating in a reduction/oxidation reaction at the surface of the first electrode under conditions whereby an electrical potential is applied to the electrodes, wherein each of the labeled chain-terminating nucleotide species has a specific reduction/oxidation potential, wherein a current is produced in the apparatus when a biological sample comprising a nucleic acid that hybridizes to an oligonucleotide contained in the oligonucleotide array is incubated in the reaction chamber under moderate to high stringency hybridization conditions and the nucleotide sequence of said hybridized oligonucleotide is extended by the incorporation of at least one of the chain-terminating nucleotide and a voltage is applied to the electrodes at a potential specific for the reduction/oxidation potential of the electrochemical label.

3. The apparatus of claim 2 wherein the oligonucleotide array is an addressable array, and wherein the first electrode comprises a plurality of electrodes corresponding to each address of said addressable array, wherein a current is produced at a particular address of said addressable array after single base extension of an oligonucleotide at said address of the array with a chain terminating nucleotide species labeled with an electrochemical reporter when a voltage is applied to the electrodes at a potential specific for the reduction/oxidation potential of the electrochemical label.

4. The apparatus of claim 2 wherein the chain-terminating nucleotide species are labeled with a transition metal complex.

5. An apparatus for electrical detection of molecular interactions between an immobilized probe and a target molecule, comprising:
(a) a supporting substrate,
(b) a plurality of microelectrodes in contact with the supporting substrate to which probes are immobilized,
(c) at least one counter-electrode in contact with the supporting substrate,
(d) an AC/DC voltage source for producing electrical impedance at each microelectrode,
(e) an electrical detector for detecting changes in impedance at each microelectrode in the presence or absence of a target molecule, and
(f) an electrolyte solution in contact with the plurality of microelectrodes and the counter-electrode, wherein molecular interactions between the immobilized probe and the target molecule are detected by detecting changes in the electrical impedance in the presence and absence of the target molecule.

6. An apparatus for electrical detection of molecular interactions between an immobilized probe and a target molecule, comprising:
(a) a supporting substrate,
(b) a plurality of microelectrodes in contact with the supporting substrate,
(c) a plurality of conjugated polymer films in contact with the microelectrodes and to which probes are immobilized,
(d) at least one counter-electrode in contact with the supporting substrate,
(e) an AC/DC voltage source for producing electrical impedance at each microelectrode,
(f) an electrical detector for detecting changes in impedance at each microelectrode in the presence or absence of a target molecule, and
(g) an electrolyte solution in contact with the plurality of microelectrodes, plurality of conjugated polymer films, and the counter-electrode, wherein molecular interactions between the immobilized probe and the target molecule are detected by detecting changes in the electrical impedance in the presence and absence of the target molecule.

7. An apparatus for electrical detection of molecular interactions between an immobilized probe and a target molecule, comprising:
(a) a supporting substrate,
(b) a plurality of microelectrodes in contact with the supporting substrate,
(c) a plurality of polymer gel pads in contact with the microelectrodes and to which probes are immobilized,
(d) at least one counter-electrode in contact with the supporting substrate,
(e) an AC/DC voltage source for producing electrical impedance at each microelectrode,
(f) an electrical detector for detecting changes in impedance at each microelectrode in the presence or absence of a target molecule, and
(g) an electrolyte solution in contact with the plurality of microelectrodes, plurality of polyacrylamide gel pads, and the counter-electrode, wherein molecular interactions between the immobilized probe and the target molecule are detected by detecting changes in the electrical impedance in the presence and absence of the target molecule.
